(19) United States
(12) Patent Application Publication
(10) Pub. No.: US 2023/0252899 A1
(43) Pub. Date: Aug. 10, 2023

(54) TRAFFIC CONTROL DEVICE, TRAFFIC CONTROL SYSTEM, AND TRAFFIC CONTROL METHOD

(71) Applicant: Mitsubishi Electric Corporation, Tokyo (JP)

(72) Inventors: Yoshiki KANDA, Tokyo (JP); Toshihide Satake, Tokyo (JP); Haiyue Zhang, Tokyo (JP)

(73) Assignee: Mitsubishi Electric Corporation, Tokyo (JP)

(21) Appl. No.: 18/096,145

(22) Filed: Jan. 12, 2023

(30) Foreign Application Priority Data
Feb. 9, 2022 (JP) 2022-018565

(51) Int. Cl. G08G 1/16; B60W 60/00; B60W 30/095; B60W 40/04; G08G 1/09

(52) U.S. Cl. CPC G08G 1/166; B60W 60/0015; B60W 30/0956; B60W 40/04; G08G 1/093; G08G 1/164; B60W 2554/408

(57) ABSTRACT

A traffic control device of the present disclosure includes: a communication unit which receives target passing direction information and traffic information about moving objects in an intersection area transmitted from a traffic environment recognition device which acquires the traffic information; a pass schedule generation unit which predicts behaviors in the intersection area for each moving object to pass an intersection, on the basis of the traffic information and the target passing direction information, and generates a pass schedule in the intersection for each moving object; a collision judgment unit which judges a collision occurrence possibility in the intersection on the basis of the pass schedules; a passing order rank setting unit which sets passing order ranks if it is judged that collision will occur; and an adjusted pass schedule generation unit which generates adjusted pass schedules.

### BACKGROUND OF THE DISCLOSURE

### 1. Field of the Disclosure

The present disclosure relates to a traffic control device, a traffic control system, and a traffic control method.

### 2. Description of the Background Art

A traffic control device manages the traveling states of vehicles in a vehicle traveling system and performs necessary adjustment when, for example, there is a collision possibility. At an intersection, the traffic control device acquires information of positions and speeds about vehicles, pedestrians, and obstacles in the intersection and around the intersection, and transmits a driving command or a waiting command to each vehicle so that the vehicles and the like will not cause collision, on the basis of the acquired information.

The traffic control device needs to cause the vehicles to pass the intersection as smoothly as possible while preventing the vehicles from causing collision. Patent Document 1 discloses an operation determination device which determines operation for an ego vehicle to avoid collision with an obstacle on the basis of a detection result for the present position of the obstacle when the vehicle is about to enter a T junction.

According to the operation determination device described in Patent Document 1, whether or not an obstacle is present in one predetermined area including an intersection is confirmed, and if an obstacle is present in the predetermined area, the ego vehicle stops once before entering the intersection, and enters the intersection after the obstacle goes out of the predetermined area.
Patent Document 1: Japanese Laid-Open Patent Publication No. 2019-172068

However, in the operation determination device described in Patent Document 1, when the ego vehicle is to enter the intersection, presence of another vehicle in the intersection is confirmed first, and even if there is no collision risk because the advancing route of the ego vehicle and the advancing route of another vehicle do not overlap each other, the ego vehicle waits until the other vehicle passes from the inside to the outside of the intersection. Therefore, in a case where a plurality of passing vehicles are present in the intersection, the entire passing efficiency is reduced. Thus, the waiting period is prolonged more than necessary, so that traffic smoothness at the intersection might be lost.

In addition, in the operation determination device described in Patent Document 1, only presence of a vehicle in an intersection is confirmed and a case where a pedestrian crosses a crosswalk adjacent to an intersection is not considered at all. Therefore, the operation determination device described in Patent Document 1 might not be able to determine operation of a vehicle appropriately in a situation where a pedestrian is present.

### SUMMARY OF THE DISCLOSURE

The present disclosure has been made to solve the above problem, and an object of the present disclosure is to provide a traffic control device, a traffic control system, and a traffic control method that can easily achieve smooth movements at an intersection where vehicles and pedestrians are present together.

A traffic control device according to the present disclosure includes: a communication unit which receives traffic information about a plurality of moving objects present in an intersection area including an intersection and an area around the intersection, the traffic information being transmitted from a traffic environment recognition device for acquiring the traffic information, and target passing direction information transmitted from, among the plurality of moving objects, a moving object capable of communication; a pass schedule generation unit which predicts a behavior in the intersection area for each of the plurality of moving objects to pass the intersection, on the basis of the traffic information and the target passing direction information, and generates a pass schedule in the intersection for each of the plurality of moving objects; a collision judgment unit which judges a possibility of collision between the plurality of moving objects in the intersection on the basis of the pass schedules; a passing order rank setting unit which sets passing order ranks for the plurality of moving objects to pass the intersection, if the collision judgment unit judges that there is a possibility of causing collision between the plurality of moving objects; and an adjusted pass schedule generation unit which generates adjusted pass schedules by adjusting the pass schedules using the passing order ranks.

A traffic control system according to the present disclosure includes the traffic environment recognition device and the above traffic control device.

A traffic control method according to the present disclosure includes: a communication step of receiving traffic information about a plurality of moving objects present in an intersection area including an intersection and an area around the intersection, the traffic information being transmitted from a traffic environment recognition device for acquiring the traffic information, and target passing direction information transmitted from, among the plurality of moving objects, a moving object capable of communication; a pass schedule generation step of predicting a behavior in the intersection area for each of the plurality of moving objects to pass the intersection, on the basis of the traffic information and the target passing direction information, and generating a pass schedule in the intersection for each of the plurality of moving objects; a collision judgment step of judging a possibility of collision between the plurality of moving objects in the intersection on the basis of the pass schedules; a passing order rank setting step of setting passing order ranks for the plurality of moving objects to pass the intersection, if it is judged in the collision judgment step that there is a possibility of causing collision between the plurality of moving objects; and an adjusted pass schedule generation step of generating adjusted pass schedules by adjusting the pass schedules using the passing order ranks.

The traffic control device according to the present disclosure makes it possible to easily achieve smooth movements while avoiding occurrence of collision at an intersection where vehicles and pedestrians are present together.

The traffic control system according to the present disclosure makes it possible to easily achieve smooth movements while avoiding occurrence of collision at an intersection where vehicles and pedestrians are present together.

The traffic control method according to the present disclosure makes it possible to easily achieve smooth movements while avoiding occurrence of collision at an intersection where vehicles and pedestrians are present together.

### BRIEF DESCRIPTION OF THE DRAWINGS

FIG. 1 is a conceptual diagram showing a traffic control device and a traffic control system according to the first embodiment of the present disclosure;

FIG. 2 is a function block diagram showing the configuration of the traffic control device according to the first embodiment;

FIG. 3 is a schematic diagram showing virtual divisional areas in an intersection;

FIG. 4 is a schematic diagram illustrating area setting for an intersection in a case where the intersection is a crossroad where a two-lane road and a two-lane road cross each other;

FIG. 5A to FIG. 5C are schematic diagrams illustrating entry possibility maps for a pedestrian in the traffic control device according to the first embodiment;

FIG. 6A to FIG. 6C are schematic diagrams illustrating entry possibility maps for a manual driving vehicle in the traffic control device according to the first embodiment;

FIG. 7A to FIG. 7D are schematic diagrams illustrating an entry possibility map for a pedestrian group in the traffic control device according to the first embodiment;

FIG. 8 is a schematic diagram illustrating a being-passed area and a to-be-passed area in the traffic control device according to the first embodiment;

FIG. 9A to FIG. 9B are schematic diagrams showing a method for determining a being-passed area and a to-be-passed area from an entry possibility map in the traffic control device according to the first embodiment;

FIG. 10 is a schematic diagram illustrating setting of an application range of a being-passed area and a to-be-passed area at an intersection in the traffic control device according to the first embodiment;

FIG. 11 is a schematic diagram illustrating calculation of an application range of a pass schedule for an autonomous driving vehicle to pass an intersection in the traffic control device according to the first embodiment;

FIG. 12 is a schematic diagram illustrating a pass schedule in each virtual divisional area of an intersection in the traffic control device according to the first embodiment;

FIG. 13A to FIG. 13D are schematic diagrams illustrating generation of a pass schedule in a case where an autonomous driving vehicle moves straight through an intersection, in the traffic control device according to the first embodiment;

FIG. 14 illustrates a pass schedule in each virtual divisional area in the case where the autonomous driving vehicle moves straight through the intersection, in the traffic control device according to the first embodiment;

FIG. 15A to FIG. 15D are schematic diagrams illustrating generation of a pass schedule in a case where an autonomous driving vehicle turns left at an intersection, in the traffic control device according to the first embodiment;

FIG. 16 illustrates a pass schedule in each virtual divisional area in the case where the autonomous driving vehicle turns left at the intersection, in the traffic control device according to the first embodiment;

FIG. 17A to FIG. 17D are schematic diagrams illustrating generation of a pass schedule in a case where an autonomous driving vehicle turns right at an intersection, in the traffic control device according to the first embodiment;

FIG. 18 illustrates a pass schedule in each virtual divisional area in the case where the autonomous driving vehicle turns right at the intersection, in the traffic control device according to the first embodiment;

FIG. 19 is a schematic diagram illustrating a case where a plurality of autonomous driving vehicles enter an intersection, in the traffic control device according to the first embodiment;

FIG. 20A to FIG. 20D are schematic diagrams illustrating a pass schedule for each autonomous driving vehicle to enter the intersection, in the traffic control device according to the first embodiment;

FIG. 21A to FIG. 21D are schematic diagrams illustrating a pass schedule for each autonomous driving vehicle to enter the intersection, in the traffic control device according to the first embodiment;

FIG. 22 illustrates pass schedules in each virtual divisional area for respective autonomous driving vehicles in a case where a plurality of autonomous driving vehicles enter an intersection, in the traffic control device according to the first embodiment;

FIG. 23 illustrates an example of a brief collision judgment criterion in the traffic control device according to the first embodiment;

FIG. 24 illustrates an example of a brief collision judgment criterion in the traffic control device according to the first embodiment;

FIG. 25 illustrates an example of a priority judgment criterion in the traffic control device according to the first embodiment;

FIG. 26 illustrates an example of a priority judgment criterion in the traffic control device according to the first embodiment;

FIG. 27 illustrates pass schedules after adjustment in each virtual divisional area for respective vehicles in a case where a plurality of vehicles enter an intersection, in the traffic control device according to the first embodiment;

FIG. 28 is a schematic diagram illustrating an example in which a pedestrian and a plurality of vehicles enter an intersection, in the traffic control device according to the first embodiment;

FIG. 29 is a schematic diagram illustrating an example in which a plurality of vehicles enter an intersection, in the traffic control device according to the first embodiment;

FIG. 30 is a schematic diagram illustrating an example in which a pedestrian and a plurality of vehicles enter an intersection, in the traffic control device according to the first embodiment;

FIG. 31 is a function block diagram showing an example of a hardware configuration for implementing the traffic control device according to the first embodiment;

FIG. 32 is a flowchart showing the entire operation of the traffic control device according to the first embodiment;

FIG. 33 is a flowchart showing operation of pedestrian behavior prediction in the traffic control device according to the first embodiment;

FIG. 34 is a flowchart showing collision judgment in the traffic control device according to the first embodiment;

FIG. 35 is a flowchart showing a method for determining passing order ranks at an intersection in the traffic control device according to the first embodiment;

FIG. 36 is a flowchart showing a method for adjusting pass schedules in the traffic control device according to the first embodiment; and

FIG. 37 is a flowchart showing a command generation method in the traffic control device according to the first embodiment.

### DETAILED DESCRIPTION OF THE PREFERRED EMBODIMENTS OF THE DISCLOSURE

### First Embodiment

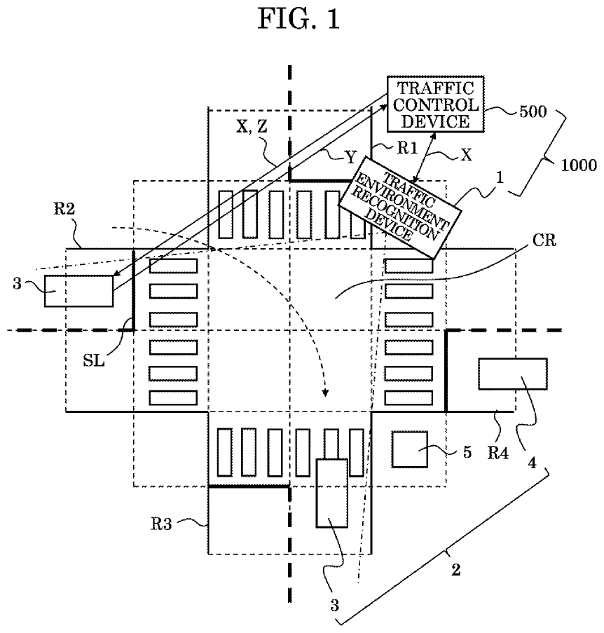

A traffic control device and a traffic control system according to the first embodiment of the present disclosure will be described with reference to FIG. 1 to FIG. 37. FIG. 1 is a conceptual diagram showing a traffic control device 500 and a traffic control system 1000 according to the first embodiment.

The traffic control system 1000 includes the traffic control device 500 and a traffic environment recognition device 1 installed on a roadside or the like of an intersection CR. In FIG. 1, only one traffic environment recognition device 1 is shown, but a plurality of traffic environment recognition devices 1 may be installed at the intersection CR. That is, the traffic control system 1000 includes one or a plurality of traffic environment recognition devices 1.

The traffic control device 500 according to the first embodiment receives traffic information X from the traffic environment recognition device 1, and receives target passing direction information Y from an autonomous driving vehicle 3 that passes the intersection CR. In addition, the traffic control device 500 generates a command Z on the basis of the traffic information X and the target passing direction information Y, and transmits the traffic information X and the command Z to the autonomous driving vehicle 3.

The traffic environment recognition device 1 is provided with sensors such as a camera and a radar, a communication device (which are not shown), and the like. In a sensor recognition range S, the traffic environment recognition device 1 acquires, in real time, the traffic information X including information about the intersection CR, the number of vehicles that are traveling or waiting in the intersection CR and around the intersection CR, the number of pedestrians 5, the shapes, positions, orientations, and speeds of autonomous driving vehicles 3, manual driving vehicles 4, and the pedestrians 5, etc. In the following description, the autonomous driving vehicles 3 and the manual driving vehicles 4 are collectively referred to simply as vehicles 2. In addition, the vehicles 2 and the pedestrians 5 may be referred to as moving objects 6. The intersection CR and the area around the intersection CR may be together referred to as an intersection area.

The traffic environment recognition device 1 transmits the above traffic information X to the traffic control device 500. In addition, as described later, in a case where a plurality of traffic environment recognition devices 1 are installed on a roadside or the like of one intersection CR, pieces of traffic information X of the respective traffic environment recognition devices 1 synchronized by the traffic control device 500 are further transmitted from the traffic control device 500.

The autonomous driving vehicle 3 is an autonomous driving vehicle provided with a vehicle traveling system for controlling the ego vehicle. Operation of the autonomous driving vehicle 3 is controlled on the basis of a control command from the vehicle traveling system (not shown) provided to the ego vehicle. In addition, communication between the autonomous driving vehicle 3 and the traffic control device 500 is also performed by the vehicle traveling system. In the following description, internal processing in the autonomous driving vehicle 3 is not described.

The autonomous driving vehicle 3 transmits the passing direction of the ego vehicle at the intersection CR, e.g., moving straight, turning left, or turning right, as the target passing direction information Y, to the traffic control device 500. In addition, the autonomous driving vehicle 3 receives the traffic information X and the command Z from the traffic control device 500. Then, the autonomous driving vehicle 3 uses the traffic information X for control of the ego vehicle as necessary, and also, on the basis of the command Z, performs operation such as delaying the time for the ego vehicle to enter the intersection CR or waiting at a position before a stop line SL.

Normally, the manual driving vehicle 4 is not provided with a vehicle traveling system, and travels in accordance with driver's intention. Therefore, irrespective of the traffic control system 1000, the manual driving vehicle 4 travels on the basis of the own determination in accordance with the driver's intention. However, the manual driving vehicle 4 may be provided with a communication device capable of transmission/reception to/from the traffic environment recognition device 1, and may receive information of passing order ranks described later or the traffic information X transmitted from the traffic environment recognition device 1. Further, the manual driving vehicle 4 may act on the basis of information such as the passing order ranks.

The pedestrian 5 is a human present in the intersection area, in particular, near a crosswalk. The pedestrian 5 may be merely walking, may be stopped, or may be running. Irrespective of the traffic control system 1000, each pedestrian 5 passes the intersection CR and the area around the intersection CR, i.e., the intersection area, on the basis of the own determination in accordance with the intention of the individual pedestrian 5. However, the pedestrian 5 may have a communication device capable of transmission/reception to/from the traffic environment recognition device 1, and may receive the information of passing order ranks described later or the traffic information X transmitted from the traffic environment recognition device 1, using a carried mobile terminal, for example. Further, the pedestrian 5 may act on the basis of information such as the passing order ranks.

The traffic control device 500 collects vehicle information of each vehicle which is information about the autonomous driving vehicles 3, and object information which is information about the manual driving vehicles 4 and the pedestrians 5. Here, the “vehicle information” includes the position and the speed of each autonomous driving vehicle 3 obtained from the traffic information X, and the passing direction of each autonomous driving vehicle 3 at the intersection CR obtained from the target passing direction information Y. In addition, when the autonomous driving vehicle 3 is waiting in accordance with a command from the traffic control device 500, the “vehicle information” includes a waiting period of the autonomous driving vehicle 3 that is waiting.

On the other hand, the “object information” about the manual driving vehicles 4 and the pedestrians 5 includes the position, the orientation, and the speed of each of the manual driving vehicles 4 and the pedestrians 5 obtained from the traffic information X.

Actual intersections CR may have various configurations and shapes. The intersection CR shown as an example in the first embodiment is a crossroad where roads each having two lanes (i.e., two vehicles can be placed in the width direction) cross each other. If each two-lane road is considered to be two roads, four roads are connected to the intersection CR.

In the conceptual diagram of the intersection area shown in FIG. 1, of the roads along the up-down direction in FIG. 1, a road on the right side is defined as a road R1 and a road on the left side is defined as a road R3, and of the roads along the left-right direction in FIG. 1, a road on the upper side is defined as a road R2 and a road on the lower side is defined as a road R4. On the roads R1, R2, R3, R4, stop lines SL are provided at positions separated from the intersection CR by predetermined distances. In the first embodiment, the autonomous driving vehicle 3 passes on the left side of each road. Therefore, the stop line SL is also provided on the left lane of the two lanes with respect to the advancing direction.

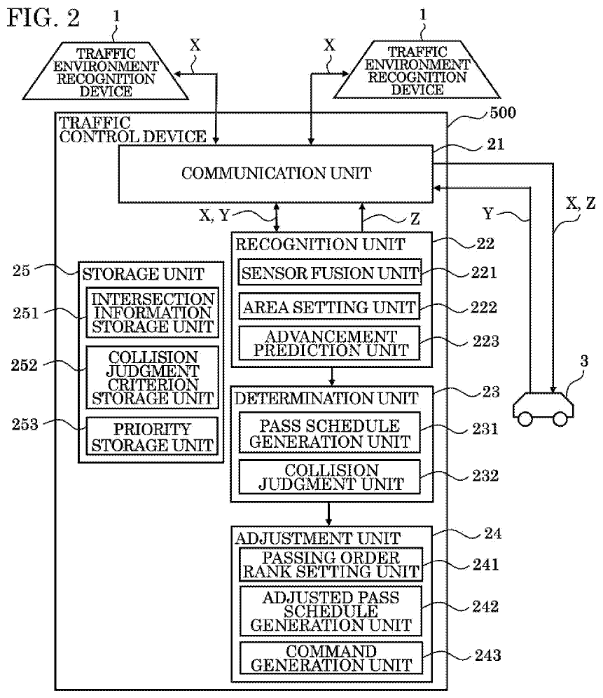

FIG. 2 is a function block diagram showing the configuration of the traffic control device 500 according to the first embodiment. The traffic control device 500 includes: a communication unit 21 for performing communication between the traffic environment recognition device 1 and the autonomous driving vehicle 3; a recognition unit 22 which integrates the traffic information X acquired from the traffic environment recognition device 1 and the target passing direction information Y acquired from the autonomous driving vehicle 3 by sensor fusion technology which is known technology, and performs behavior prediction for the manual driving vehicles 4 and the pedestrians 5; a determination unit 23 which determines the possibility of collision between the vehicle 2 and the vehicle 2 or between the vehicle 2 and the pedestrian 5; an adjustment unit 24 which generates the command Z for adjusting traveling of the autonomous driving vehicle 3; and a storage unit 25 in which basic information used for generating the command Z is stored in advance.

The communication unit 21 receives the traffic information X from one or a plurality of traffic environment recognition devices 1, and receives the target passing direction information Y from one or a plurality of autonomous driving vehicles 3. The communication unit 21 transmits the traffic information X and the target passing direction information Y to the recognition unit 22. In addition, the communication unit 21 transmits the traffic information X or the integrated traffic information X and the command Z to the autonomous driving vehicle 3.

The recognition unit 22 includes a sensor fusion unit 221 which integrates pieces of information from various sensors mainly provided to the traffic environment recognition device 1, an area setting unit 222 which sets a plurality of virtual divisional areas in the intersection CR, and an advancement prediction unit 223 which predicts the positions in the future (future positions) and the movement directions, i.e., behaviors, of the manual driving vehicles 4 and the pedestrians 5, on the basis of known technology.

The recognition unit 22 integrates pieces of the traffic information X received from one or a plurality of traffic environment recognition devices 1, by the sensor fusion unit 221, and the integrated traffic information X is returned to the communication unit 21. In this way, integration of pieces of the traffic information X when there are a plurality of traffic environment recognition devices 1 is performed by the recognition unit 22 of the traffic control device 500.

The sensor fusion unit 221 performs sensor fusion processing using known sensor fusion technology. The sensor fusion technology is technology of fusing a plurality of sensor outputs (positions, speeds, etc.) and performing processing by combining the outputs from the sensors on the basis of measurement accuracies of the sensors and the like. As an example of the sensor fusion technology, the respective relative positions may be weighted and averaged. Using the sensor fusion technology obtains a detection result that is significantly higher in accuracies such as position accuracy, as compared to a case of processing the output of each sensor individually.

The area setting unit 222 sets a plurality of virtual divisional areas in the intersection area on the basis of a predetermined criterion. The setting method for the virtual divisional areas differs depending on the configuration of the intersection CR. In the first embodiment, the intersection area is virtually divided to set sixteen virtual divisional areas. Specific divisions of the virtual divisional areas will be described later. In the following description and the drawings, each “virtual divisional area” may be simply referred to as an “area”.

The advancement prediction unit 223 predicts (advancement prediction) the positions in the future (future positions), the movement directions, and the like, i.e., behaviors, of the manual driving vehicles 4 and the pedestrians 5 in the intersection area, on the basis of known technology. The behavior prediction based on known technology is, for example, technology in which subsequent behaviors from the present time are predicted through linear approximation from information such as the present positions, the speeds, and the orientations of the manual driving vehicles 4 and the pedestrians 5, these are compared with information acquired at each time, and the prediction is corrected. The autonomous driving vehicles 3 are excluded from subjects of the behavior prediction based on known technology. This is because, for the autonomous driving vehicles 3, behavior prediction is performed on the basis of the target passing direction information Y transmitted from the autonomous driving vehicles 3.

Using behavior prediction results for the manual driving vehicles 4 and the pedestrians 5, an entry possibility map for each of the manual driving vehicles 4 and the pedestrians 5 is individually generated in the plurality of virtual divisional areas of the intersection area. In addition, the generated entry possibility maps are compared with actual behavior results of the manual driving vehicles 4 and the pedestrians 5, and if there is a difference at a certain degree or greater therebetween, an entry possibility map is generated again in consideration of the difference therebetween. After the entry possibility maps are generated, the entry possibility maps of all the pedestrians 5 are integrated to generate an entry possibility map for a pedestrian group. Specific description of the entry possibility map will be given later.

The determination unit 23 includes a pass schedule generation unit 231 which predicts and generates a pass schedule for each of the vehicles 2 and the pedestrians 5 to pass the intersection CR, and a collision judgment unit 232 which judges whether or not there is a possibility of causing collision between the vehicle 2 and the vehicle 2 and between the vehicle 2 and the pedestrian 5, i.e., between moving objects, when a plurality of moving objects pass the intersection CR, e.g., when the vehicle 2 and the pedestrian 5 enter the intersection CR.

For the respective virtual divisional areas set by the area setting unit 222, the pass schedule generation unit 231 calculates a time at which each of the vehicles 2 and the pedestrians 5 to enter the intersection CR enters each virtual divisional area, and a time of exiting each virtual divisional area, thereby calculating a time period in which each virtual divisional area becomes a being-passed area or a time period in which each virtual divisional area becomes a to-be-passed area, thus generating a pass schedule for each of the vehicles 2 and the pedestrians 5. That is, on the basis of the traffic information X and the target passing direction information Y, the pass schedule generation unit 231 predicts a behavior in the intersection area for each of the plurality of moving objects to pass the intersection CR, thus generating a pass schedule in the intersection area for each of a plurality of moving objects.

The collision judgment unit 232 judges whether or not there is a possibility that each of the vehicles 2 and the pedestrians 5 causes collision at the intersection CR, on the basis of a predetermined collision judgment criterion and the pass schedules of the vehicles 2 and the pedestrians 5 generated by the pass schedule generation unit 231.

The adjustment unit 24 includes: a passing order rank setting unit 241 which sets passing order ranks which are an order for each of the vehicles 2 and the pedestrians 5 to pass the intersection CR, if the above collision judgment unit 232 judges that there is a possibility of collision when each of the vehicles 2 and the pedestrians 5 passes the intersection CR; an adjusted pass schedule generation unit 242 which adjusts the pass schedule as necessary, to generate an adjusted pass schedule, and a command generation unit 243 which generates the command Z for the autonomous driving vehicle 3.

If, with respect to the generated pass schedules of the moving objects, the collision judgment unit 232 judges that there is a possibility of collision on the basis of the collision judgment criterion, the passing order rank setting unit 241 sets passing order ranks as an order for each of the vehicles 2 and the pedestrians 5 to pass the intersection CR, on the basis of predetermined priorities.

If the collision judgment unit 232 judges that there is a possibility of collision, the adjusted pass schedule generation unit 242 compares the pass schedules of the respective vehicles 2 and pedestrians 5 judged to have a possibility of collision, and calculates such an adjustment period as to enable avoidance of collision, thereby adjusting the pass schedules. That is, the adjusted pass schedule generation unit 242 generates the adjusted pass schedule for each moving object 6 that is a subject. The adjustment method for the pass schedules will be described later.

The command generation unit 243 generates the command Z for each autonomous driving vehicle 3 to enter the intersection CR, on the basis of the pass schedule calculated by the pass schedule generation unit 231 or the adjusted pass schedule adjusted by the adjusted pass schedule generation unit 242.

Examples of the command Z include a maintaining command for causing each autonomous driving vehicle 3 to pass the intersection CR as it is in the present state, an adjustment command for delaying a time for each autonomous driving vehicle 3 to enter the intersection CR, and a waiting command for temporarily stopping entry of each autonomous driving vehicle 3 into the intersection CR.

The storage unit 25 includes an intersection information storage unit 251, a collision judgment criterion storage unit 252, and a priority storage unit 253.

In the intersection information storage unit 251, information about an intersection area and setting for virtual divisional areas in the intersection area, is stored. In the intersection information storage unit 251, map information including data of the position, i.e., the latitude and the longitude, of the intersection CR, and the shape of the intersection CR, is stored.

The aforementioned area setting unit 222 adds setting information for the virtual divisional areas, which is, in the first embodiment, information about divisions of the intersection CR, to the map information stored in the intersection information storage unit 251, so as to update the map information of the intersection CR, thus setting the virtual divisional areas. The setting for the virtual divisional areas of the intersection area is performed before operation of the traffic control device 500 is started. Therefore, in the following description, the virtual divisional areas of the intersection area are assumed to be set in advance.

In the collision judgment criterion storage unit 252, the collision judgment criterion which is a criterion for performing collision judgment using the pass schedules and the entry possibility maps of the vehicles 2 and the pedestrians 5, are prepared and stored in advance. The aforementioned collision judgment unit 232 judges whether or not there is a possibility of collision between the moving objects on the basis of the collision judgment criterion stored in the collision judgment criterion storage unit 252. The specific content of the collision judgment criterion will be described later.

In the priority storage unit 253, priorities for setting the passing order ranks of the vehicles 2 and the pedestrians 5 to pass the intersection CR are stored in advance. The aforementioned passing order rank setting unit 241 sets the passing order rank of each of the vehicles 2 and the pedestrians 5 individually on the basis of the priorities stored in the priority storage unit 253. The specific content of the priorities will be described later.

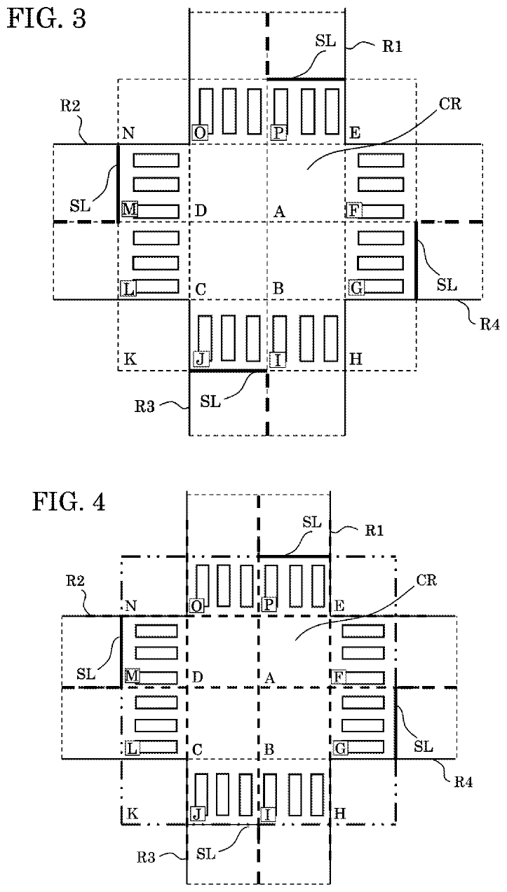

Setting for the virtual divisional areas in the intersection area will be described below. FIG. 3 is a schematic diagram showing the virtual divisional areas set in and around the intersection CR, i.e., in the intersection area. The intersection CR shown in FIG. 3 is a crossroad where the road R1 and the road R3, and the road R2 and the road R4, cross each other. FIG. 4 is a schematic diagram illustrating the virtual divisional areas of the intersection area in a case where the intersection is the crossroad. In FIG. 4, thick dotted lines are lines extended from the respective lane edges, and two-dot dashed lines are lines extended from places to stop before entering the intersection CR.

As shown in FIG. 4, the intersection area has widths corresponding to two lanes in each of the up-down direction and the left-right direction in the drawing. The lines extended from the respective lane edges and the lines extended from the places to stop before entering the intersection are used as division lines, to divide the intersection area into sixteen virtual divisional areas. By this division, virtual divisional areas A to P are set. In a case where a stop line SL is present on the virtual divisional area, one side of the virtual divisional area corresponds to the stop line SL.

Each virtual divisional area set in the intersection area by the area setting unit 222 has a width that allows at least one vehicle 2 to pass. That is, the virtual divisional area has a width corresponding to at least one lane in a direction perpendicular to a direction in which the vehicle 2 enters and exits. With the virtual divisional areas set as described above, the vehicle 2 sequentially passes the virtual divisional areas adjacent to each other, whereby the vehicle 2 can pass the intersection CR in any direction.

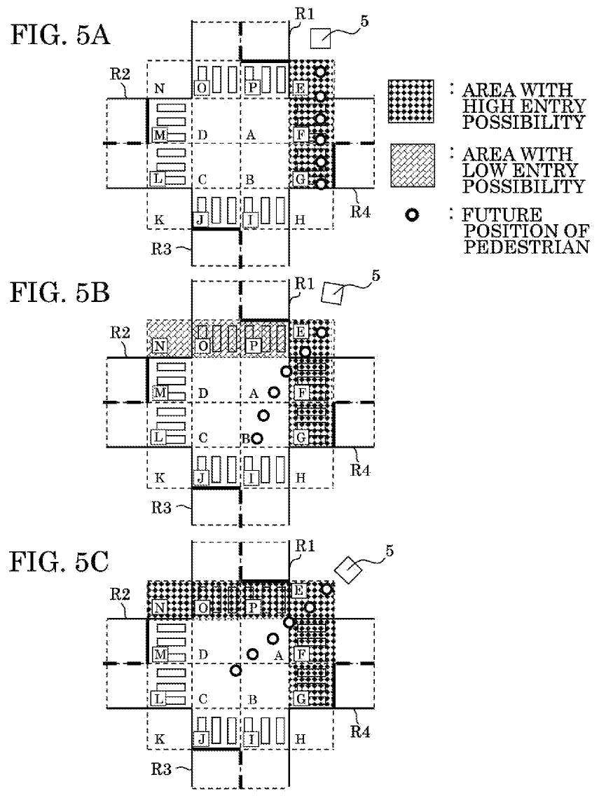

The advancement prediction unit 223 generates the entry possibility map for each of the manual driving vehicles 4 and the pedestrians 5, using, as a unit, each virtual divisional area set by the area setting unit 222. FIG. 5A to 5C are schematic diagrams illustrating the entry possibility maps for the pedestrian 5 in the traffic control device 500 according to the first embodiment. In FIG. 5A to 5C, black outline circles indicate future positions of the pedestrian 5 obtained by known behavior prediction technology.

In FIG. 5A to 5C, FIG. 5A shows the entry possibility map indicating a situation in which the behavior is predicted such that the pedestrian 5 will walk on the crosswalk crossing the road R2 and the road R4 from a position near the virtual divisional area E, FIG. 5B shows the entry possibility map indicating a situation in which the behavior is predicted such that the pedestrian 5 will enter the intersection CR from a position near the virtual divisional area E and move toward the virtual divisional area I, and FIG. 5C shows the entry possibility map indicating a situation in which the behavior is predicted such that the pedestrian 5 will enter the intersection CR from a position near the virtual divisional area E in the drawing and move on a diagonal line toward the virtual divisional area K.

On the basis of the future positions of the pedestrian 5 obtained by known behavior prediction technology, a virtual divisional area where the possibility for the pedestrian 5 to enter is high is determined, and this area is set as a “high-possibility area”. In FIG. 5A to 5C, the “high-possibility area” is indicated by a black rhombus grid pattern. On the other hand, a virtual divisional area where the possibility for the pedestrian 5 to enter is low is determined, and this area is set as a “low-possibility area”. In FIG. 5A to 5C, the “low-possibility area” is indicated by a brick-like grid pattern.

In FIG. 5A, since the behavior is predicted such that the pedestrian 5 will walk on the crosswalk crossing the road R2 and the road R4 from the position near the virtual divisional area E, the virtual divisional areas E, F, and G are determined to be high-possibility areas. In FIG. 5B, since the behavior is predicted such that the pedestrian 5 will enter the intersection CR from the position near the virtual divisional area E and move toward the virtual divisional area I, the virtual divisional areas E, F, and G are determined to be high-possibility areas, and meanwhile, the virtual divisional areas N, O, and P are determined to be low-possibility areas. In FIG. 5C, since the behavior is predicted such that the pedestrian 5 will enter the intersection CR from the position near the virtual divisional area E in the drawing and move on the diagonal line toward the virtual divisional area K, the virtual divisional areas E, F, G, N, O, and P are determined to be high-possibility areas.

Here, whether the entry possibility of the pedestrian 5 is high or low is determined on the basis of future positions of the pedestrian 5 within a predetermined period in the above behavior prediction, reliability of the behavior prediction, or the like. The entry possibility map for the pedestrian 5 using each virtual divisional area as a unit provides an effect of reducing the calculation cost required for generation thereof. In addition, adopting such an entry possibility map for the pedestrian 5 provides an effect of ensuring a certain level of accuracy that enables generation of the pass schedule described later even if the behavior prediction is based on prediction accuracy that cannot be considered to be high.

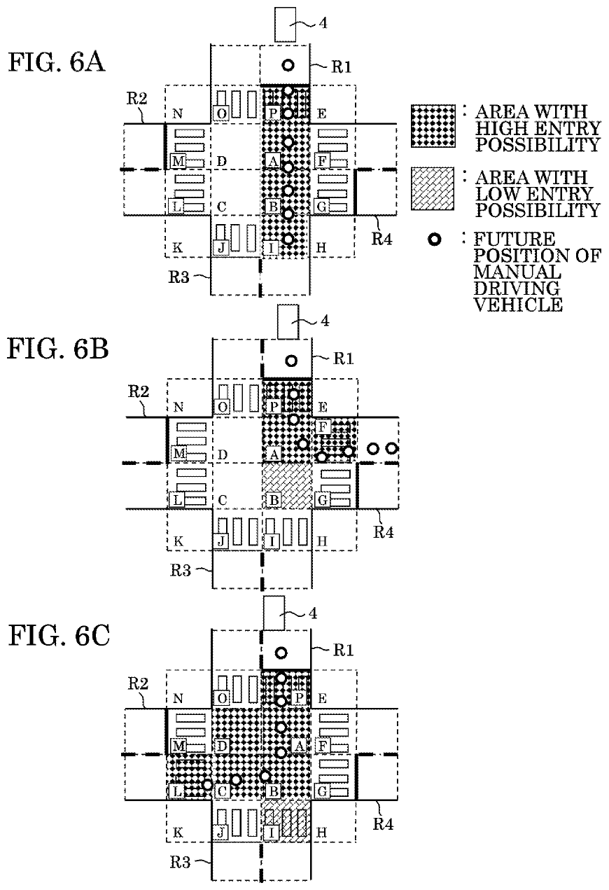

FIG. 6A to 6C are schematic diagrams illustrating the entry possibility maps for the manual driving vehicle 4 in the traffic control device 500 according to the first embodiment. In FIG. 6A to 6C, FIG. 6A shows the entry possibility map indicating a situation in which the behavior is predicted such that the manual driving vehicle 4 traveling on the road R1 will move straight through the intersection CR, FIG. 6B shows the entry possibility map indicating a situation in which the behavior is predicted such that the manual driving vehicle 4 will turn left at the intersection CR and move toward the road R2, and FIG. 6C shows the entry possibility map indicating a situation in which the behavior is predicted such that the manual driving vehicle 4 will turn right at the intersection CR and move toward the road R4.

On the basis of the future positions of the manual driving vehicle 4 obtained by known behavior prediction technology, a virtual divisional area where the possibility for the manual driving vehicle 4 to enter is high is determined, and this area is set as a “high-possibility area”. In FIG. 6A to 6C, the “high-possibility area” is indicated by a black rhombus grid pattern. On the other hand, a virtual divisional area where the possibility for the manual driving vehicle 4 to enter is low is determined, and this area is set as a “low-possibility area”. In FIG. 6A to 6C, the “low-possibility area” is indicated by a brick-like grid pattern. The possibility for the manual driving vehicle 4 to enter a subject virtual divisional area is determined on the basis of whether or not the subject virtual divisional area is a future position within a certain period, reliability of prediction, or the like.

In FIG. 6A, since the behavior is predicted such that the manual driving vehicle 4 will move straight through the intersection CR, the virtual divisional areas P, A, B, and I are determined to be high-possibility areas. In FIG. 6B, since the behavior is predicted such that the manual driving vehicle 4 will turn left at the intersection CR and move toward the road R2, the virtual divisional areas P, A, and F are determined to be high-possibility areas, and meanwhile, the virtual divisional area B is determined to be a low-possibility area. In FIG. 6C, since the behavior is predicted such that the manual driving vehicle 4 will turn right at the intersection CR and move toward the road R4, the virtual divisional areas P, D, A, L, C, and B are determined to be high-possibility areas, and meanwhile, the virtual divisional area I is determined to be a low-possibility area.

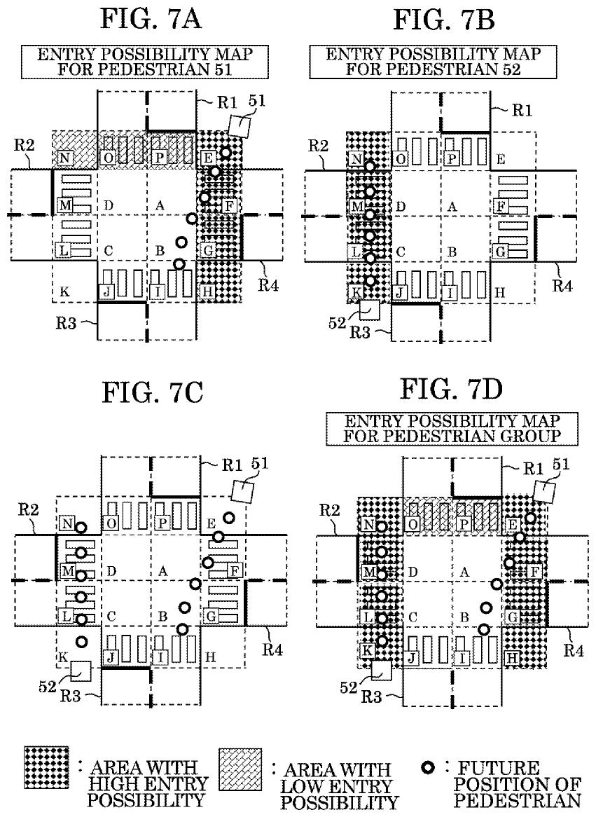

FIG. 7A to 7D are schematic diagrams illustrating the entry possibility map for the pedestrian group in the traffic control device 500 according to the first embodiment. In FIG. 7A to 7D, as an example of the pedestrian group, a case where two pedestrians 51 and 52 cross crosswalks is shown. On the basis of the entry possibility map for each of the pedestrian 51 and the pedestrian 52, the entry possibility of each of the pedestrian 51 and the pedestrian 52 into each virtual divisional area is calculated, whereby the entry possibility map for the pedestrian group is generated.

In FIG. 7A to 7D, FIG. 7A shows the entry possibility map indicating a situation in which the behavior is predicted such that the pedestrian 51 will enter the intersection CR from a position near the virtual divisional area E and move toward the virtual divisional area I, FIG. 7B shows the entry possibility map indicating a situation in which the behavior is predicted such that the pedestrian 52 will walk on a crosswalk crossing the road R2 and the road R4 from a position near the virtual divisional area K, FIG. 7C shows the behavior predictions for the pedestrian 51 and the pedestrian 52 together in one schematic diagram, and FIG. 7D shows the entry possibility map for the pedestrian group in which FIG. 7A and FIG. 7B are shown together in one diagram.

In FIG. 7A, since the behavior is predicted such that the pedestrian 51 will enter the intersection CR from the position near the virtual divisional area E and move toward the virtual divisional area I, the virtual divisional areas E, F, G, and H are determined to be high-possibility areas, and meanwhile, the virtual divisional areas P, O, and N are determined to be low-possibility areas. In FIG. 7B, since the behavior is predicted such that the pedestrian 52 will walk on the crosswalk crossing the road R2 and the road R4 from the position near the virtual divisional area K, the virtual divisional areas K, L, M, and N are determined to be high-possibility areas.

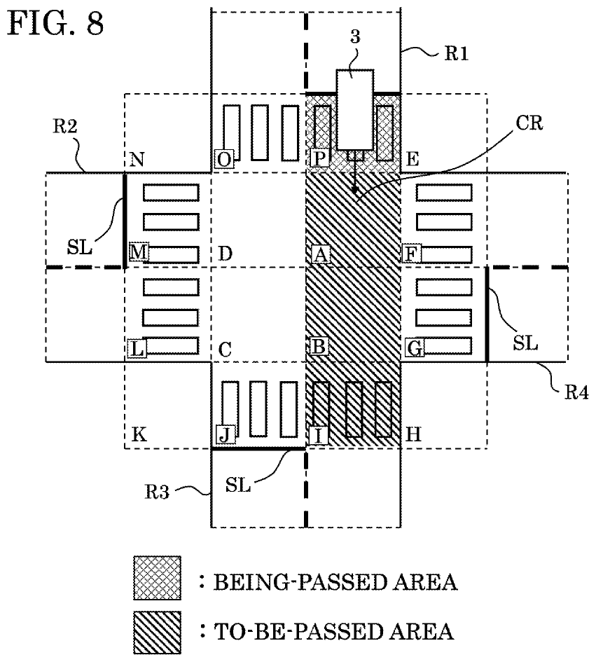

Next, the definitions of the being-passed area and the to-be-passed area will be described. FIG. 8 is a schematic diagram illustrating the being-passed area and the to-be-passed area in the traffic control device 500 according to the first embodiment. In an example shown in FIG. 8, the autonomous driving vehicle 3 to move straight to pass the intersection CR enters the intersection CR from the road R1. In this case, the autonomous driving vehicle 3 passes the virtual divisional areas in an order of P, A, B, then I. At the time when the autonomous driving vehicle 3 starts to enter the intersection CR, the autonomous driving vehicle 3 and the virtual divisional area P overlap each other. After entering the intersection CR, the autonomous driving vehicle 3 is passing the virtual divisional area P. As in the virtual divisional area P in this case, the virtual divisional area where the autonomous driving vehicle 3 is passing at present is defined as a “being-passed area”. In FIG. 8, the “being-passed area” is indicated by a rhombus grid pattern.

On the other hand, the virtual divisional areas A, B, and I are virtual divisional areas that do not overlap the autonomous driving vehicle 3 at the time when the autonomous driving vehicle 3 starts to enter the intersection CR, but will be passed by the time when the autonomous driving vehicle 3 finishes passing the intersection CR. As described above, the virtual divisional area that is not being passed at the present time but will be passed by the autonomous driving vehicle 3 by the time when the autonomous driving vehicle 3 finishes passing the intersection CR, is defined as a “to-be-passed area”. In FIG. 8, the “to-be-passed area” is indicated by a diagonal stripe pattern.

In a case where any autonomous driving vehicle 3 passes the intersection CR, which virtual divisional area becomes a being-passed area or a to-be-passed area or whether the virtual divisional area becomes neither a being-passed area nor a to-be-passed area, is determined by the passing direction of the autonomous driving vehicle 3 and the road where the autonomous driving vehicle 3 is located, i.e., from which road the autonomous driving vehicle 3 enters the intersection CR. In addition, the timing at which each virtual divisional area will become a being-passed area or a to-be-passed area is determined by the passing direction of the autonomous driving vehicle 3, the road where the autonomous driving vehicle 3 is located, and the vehicle speed thereof.

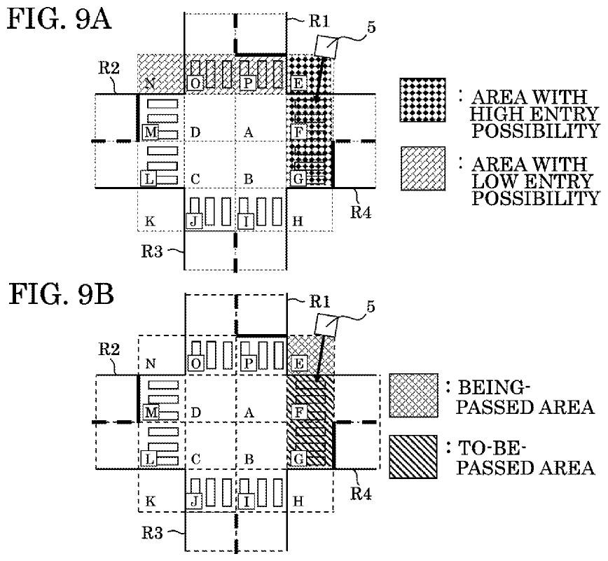

FIG. 9A to 9B are schematic diagrams showing a method for determining a being-passed area and a to-be-passed area from an entry possibility map. The virtual divisional area where the possibility of presence of the pedestrian 5 is at a certain level or higher in behavior prediction and the pedestrian 5 is present at the present time, is determined to be a “being-passed area”. Meanwhile, the virtual divisional area where, while the possibility of presence of the pedestrian 5 is at a certain level or higher in behavior prediction, the pedestrian 5 is not present at the present time but is predicted to pass within a certain period from the present time, is determined to be a “to-be-passed area”. The virtual divisional areas other than the above areas are not determined to be either a being-passed area or a to-be-passed area.

In FIG. 9A to 9B, FIG. 9A is a schematic diagram showing the entry possibility map in a case where the behavior is predicted such that the pedestrian 5 will walk on the crosswalk crossing the road R2 and the road R4 from a position near the virtual divisional area E, and FIG. 9B is a schematic diagram showing a being-passed area and a to-be-passed area generated on the basis of the entry possibility map shown in FIG. 9A, regarding the pedestrian 5.

In FIG. 9A, since the behavior is predicted such that the pedestrian 5 will walk on the crosswalk crossing the road R2 and the road R4 from the position near the virtual divisional area E, the virtual divisional areas E, F, and G are determined to be high-possibility areas, and meanwhile, the virtual divisional areas P, O, and N are determined to be low-possibility areas.

In FIG. 9B, on the basis of the entry possibility map shown in FIG. 9A, the virtual divisional area E is determined to be a being-passed area, and meanwhile, the virtual divisional areas F and G are determined to be to-be-passed areas.

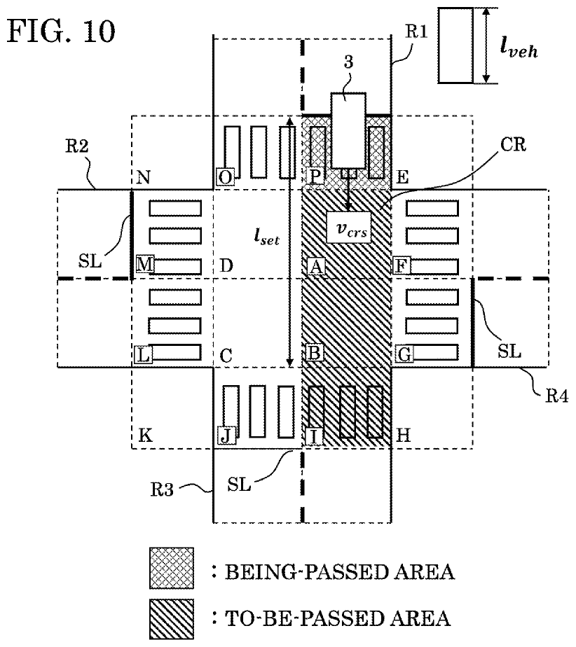

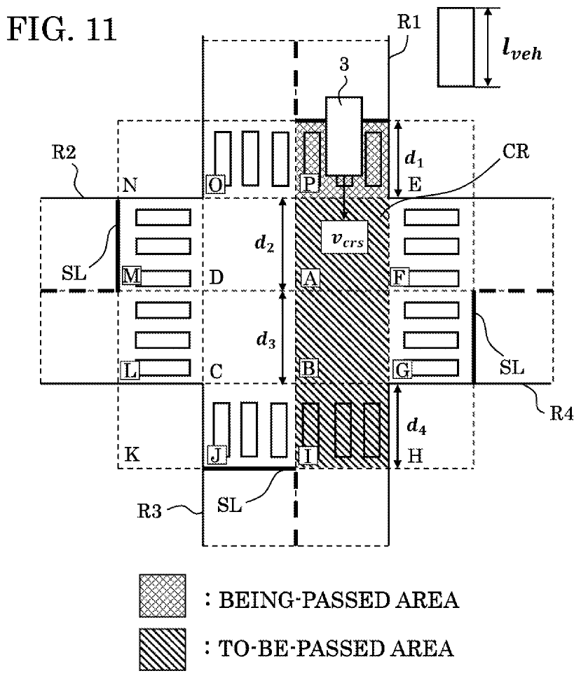

Next, an application range of a being-passed area and a to-be-passed area will be described. FIG. 10 is a schematic diagram illustrating setting of the application range of a being-passed area and a to-be-passed area at the intersection CR in the traffic control device 500 according to the first embodiment. As shown in FIG. 10, where the vehicle speed of the autonomous driving vehicle 3 is denoted by v_{crs} and a set certain period is denoted by tₛₑₜ, the following Expression (1) is satisfied.

[Mathematical 1]

lₛₑₜ=v_{crs}×tₛₑₜ (1)

Here, lₛₑₜ is a distance by which the autonomous driving vehicle 3 moves within the set certain period. Each virtual divisional area in the intersection CR within the range of the distance lₛₑₜ is set as a being-passed area or a to-be-passed area. In an example shown in FIG. 10, the virtual divisional area P is set as a being-passed area and the virtual divisional areas A, B, and I are set as to-be-passed areas.

Next, generation of the pass schedule for the autonomous driving vehicle 3 by the pass schedule generation unit 231 will be described. FIG. 11 is a schematic diagram illustrating calculation of an application range of the pass schedule for the autonomous driving vehicle 3 to pass the intersection CR. The schematic diagram of the intersection CR shown in FIG. 11 is the same as that in FIG. 10. In FIG. 11, distances d₁, d₂, d₃, and d₄ defined in the intersection CR and around the intersection CR, and parameters of the autonomous driving vehicle 3 entering the intersection CR, are shown.

As shown in FIG. 11, the autonomous driving vehicle 3 enters the intersection CR from the road R1 and moves straight to pass the virtual divisional areas P, A, B, and I. At the intersection CR, the distance from the boundary between the road R1 and the virtual divisional area P to the boundary between the virtual divisional area P and the virtual divisional area A is denoted by d₁, the distance from the boundary between the virtual divisional area P and the virtual divisional area A to the boundary between the virtual divisional area A and the virtual divisional area B is denoted by d₂, the distance from the boundary between the virtual divisional area A and the virtual divisional area B to the boundary between the virtual divisional area B and the virtual divisional area I is denoted by d₃, and the distance from the boundary between the virtual divisional area B and the virtual divisional area I to the boundary between the virtual divisional area I and the road R1 is denoted by d₄.

The vehicle body length in the advancing direction of the autonomous driving vehicle 3 is denoted by lᵥₑₕ, the vehicle speed of the autonomous driving vehicle 3 is denoted by v_{crs}, and the time when the autonomous driving vehicle 3 enters the virtual divisional area P in the intersection CR is denoted by t_{I1}. In this case, the following Expressions (2) to (8) are satisfied.

[Mathematical 2]

$${t}_{I 2} = \frac{{d}_{1}}{{v}_{crs}} + {t}_{I 1} \qquad ( 2 )$$

$${t}_{I 3} = \frac{{d}_{1} + {d}_{2}}{{v}_{crs}} + {t}_{I 1} \qquad ( 3 )$$

$${t}_{I 4} = \frac{{d}_{1} + {d}_{2} + {d}_{3}}{{v}_{crs}} + {t}_{I 1} \qquad ( 4 )$$

$${t}_{O 1} = \frac{{d}_{1} + {l}_{veh}}{{v}_{crs}} + {t}_{I 1} \qquad ( 5 )$$

$${t}_{O 2} = \frac{{d}_{1} + {d}_{2} + {l}_{veh}}{{v}_{crs}} + {t}_{I 1} \qquad ( 6 )$$

$${t}_{O 3} = \frac{{d}_{1} + {d}_{2} + {d}_{3} + {l}_{veh}}{{v}_{crs}} + {t}_{I 1} \qquad ( 7 )$$

$${t}_{O 4} = \frac{{d}_{1} + {d}_{2} + {d}_{3} + {d}_{4} + {l}_{veh}}{{v}_{crs}} + {t}_{I 1} \qquad ( 8 )$$

In Expressions (2) to (8), t_{I2} is the time when the autonomous driving vehicle 3 enters the virtual divisional area A, t_{I3} is the time when the autonomous driving vehicle 3 enters the virtual divisional area B, t_{I4} is the time when the autonomous driving vehicle 3 enters the virtual divisional area I, t_{O1} is the time when the autonomous driving vehicle 3 exits the virtual divisional area P, t_{O2} is the time when the autonomous driving vehicle 3 exits the virtual divisional area A, t_{O3} is the time when the autonomous driving vehicle 3 exits the virtual divisional area B, and t_{O4} is the time when the autonomous driving vehicle 3 exits the virtual divisional area I. The calculation method for generating the pass schedule is not limited to the above calculation method.

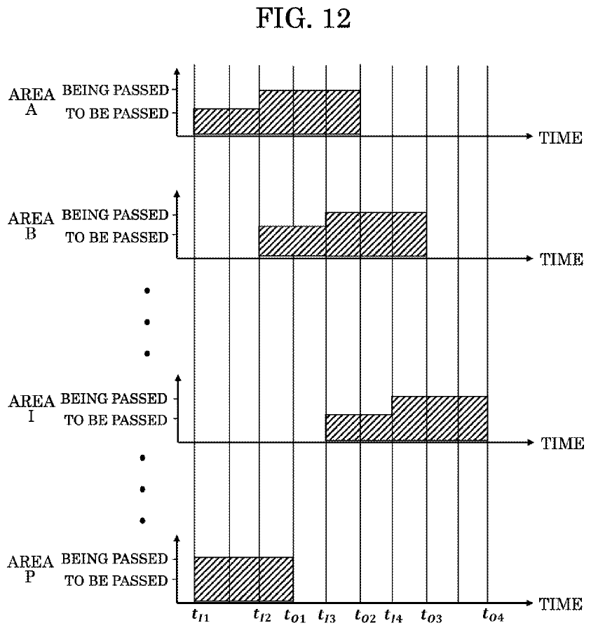

FIG. 12 shows the pass schedule for the autonomous driving vehicle 3 in each virtual divisional area, generated using Expressions (1) to (8). In the pass schedule, the horizontal axis indicates time, and the vertical axis indicates whether the virtual divisional area is a being-passed area or a to-be-passed area.

As shown in FIG. 12, during a period from time t_{I1} to time t_{I2}, the virtual divisional area P is a being-passed area and the virtual divisional area A is a to-be-passed area. During a period from time t_{I2} to time t_{O1}, the virtual divisional areas A and P are being-passed areas and the virtual divisional area B is a to-be-passed area. During a period from time t_{O1} to time t_{I3}, the virtual divisional area A is a being-passed area and the virtual divisional area B is a to-be-passed area. During a period from time t_{I3} to time t_{O2}, the virtual divisional areas A and B are being-passed areas and the virtual divisional area I is a to-be-passed area. During a period from time t_{O2} to time t_{I4}, the virtual divisional area B is a being-passed area and the virtual divisional area I is a to-be-passed area. During a period from time t_{I4} to time t_{O3}, the virtual divisional areas B and I are being-passed areas. During a period from time t_{O3} to time t_{O4}, the virtual divisional area I is a being-passed area.

In FIG. 12, an example in which the autonomous driving vehicle 3 moves straight to pass the intersection CR, is shown. However, in a case where the autonomous driving vehicle 3 turns right or left to pass the intersection CR, the vehicle speed and the traveling route of the autonomous driving vehicle 3 are different from those in the case of straight movement, and therefore the distances d₁, d₂, d₃, and d₄ and the vehicle speed v_{crs} are adjusted as appropriate.

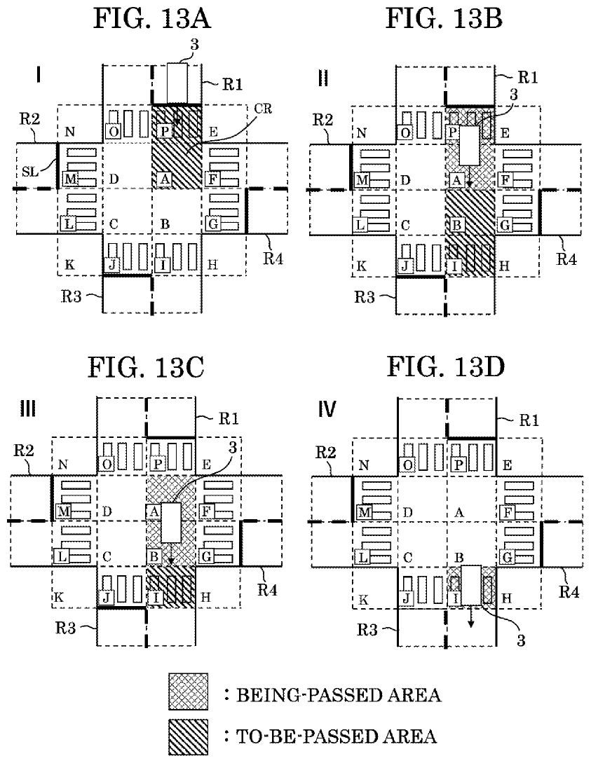

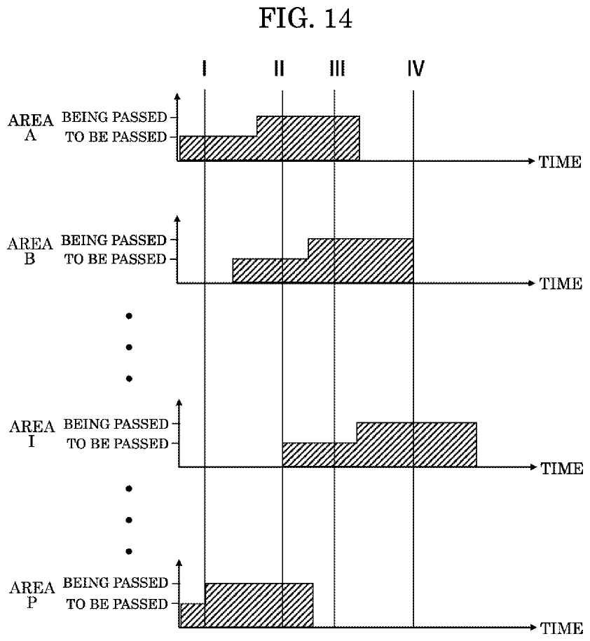

The pass schedule in a case where the autonomous driving vehicle 3 moves straight will be described with reference to FIG. 13A to 13D and FIG. 14. FIG. 13A to 13D are schematic diagrams illustrating generation of the pass schedule in a case where the autonomous driving vehicle 3 enters the intersection CR from the road R1 and moves straight through the intersection CR, in the traffic control device 500 according to the first embodiment. In an example shown in FIG. 13A to 13D, the autonomous driving vehicle 3 enters the intersection CR from the road R1, moves straight to pass the virtual divisional areas P, A, B, and I, and enters the road R1 again.

FIG. 13A shows a situation at time I when the autonomous driving vehicle 3 enters the virtual divisional area P from the road R1, FIG. 13B shows a situation at time II when the autonomous driving vehicle 3 enters the virtual divisional area A, FIG. 13C shows a situation at time III when the autonomous driving vehicle 3 enters the virtual divisional area I, and FIG. 13D shows a situation at time IV when the autonomous driving vehicle 3 enters the road R1 again from the virtual divisional area I.

FIG. 14 illustrates the pass schedule in each virtual divisional area in the case where the autonomous driving vehicle 3 moves straight through the intersection CR, in the traffic control device 500 according to the first embodiment. In FIG. 14, the entire pass schedule in the case where the autonomous driving vehicle 3 moves straight is shown for respective virtual divisional areas.

Before time I, the virtual divisional areas P and A become to-be-passed areas. At time I, the autonomous driving vehicle 3 enters the virtual divisional area P from the road R1, so that the virtual divisional area P becomes a being-passed area and the virtual divisional area A becomes a to-be-passed area. During a period from time I to time II, the virtual divisional area A changes from a to-be-passed area to a being-passed area. In addition, during the period from time I to time II, the virtual divisional area B becomes a to-be-passed area.

At time II, the virtual divisional areas P and A are being-passed areas and the virtual divisional areas B and I are to-be-passed areas. During a period from time II to time III, the virtual divisional area B changes from a to-be-passed area to a being-passed area. Meanwhile, during the period from time II to time III, the virtual divisional area P changes from a being-passed area to an area that is neither a to-be-passed area nor a being-passed area. This is because the autonomous driving vehicle 3 exits the virtual divisional area P.

At time III, the virtual divisional areas A and B are being-passed areas and the virtual divisional area I is a to-be-passed area. During a period from time III to time IV, the virtual divisional area I changes from a to-be-passed area to a being-passed area. At time IV, the virtual divisional area I is a being-passed area.

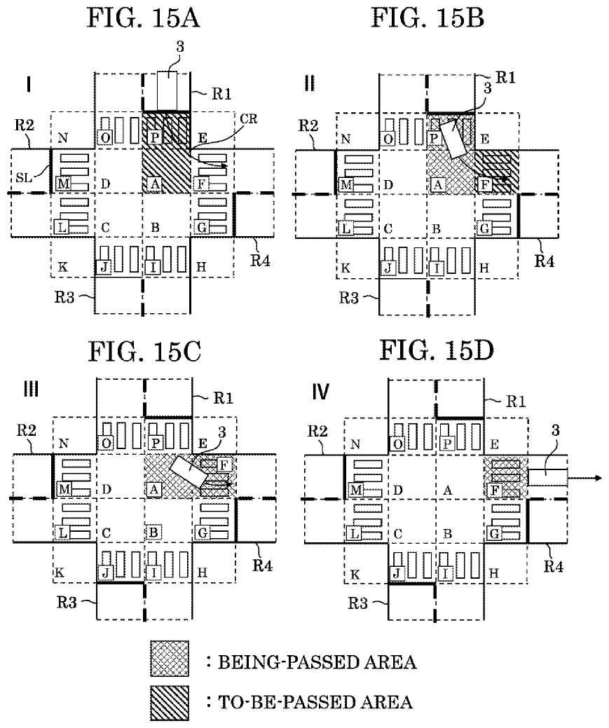

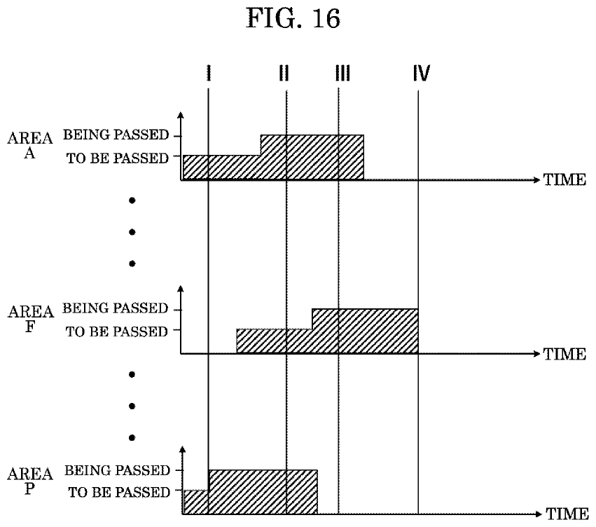

The pass schedule in a case where the autonomous driving vehicle 3 turns left will be described with reference to FIG. 15A to 15D and FIG. 16. FIG. 15A to 15D are schematic diagrams illustrating generation of the pass schedule in a case where the autonomous driving vehicle 3 turns left at the intersection CR, in the traffic control device 500 according to the first embodiment. In an example shown in FIG. 15A to 15D, the autonomous driving vehicle 3 enters the intersection CR from the road R1, turns left while passing the virtual divisional areas P, A, and F, and enters the road R2.

FIG. 15A shows a situation at time I just before the autonomous driving vehicle 3 enters the virtual divisional area P from the road R1, FIG. 15B shows a situation at time II when the autonomous driving vehicle 3 enters the virtual divisional area A, FIG. 15C shows a situation at time III when the autonomous driving vehicle 3 exits the virtual divisional area A and enters the virtual divisional area F, and FIG. 15D shows a situation at time IV when the autonomous driving vehicle 3 exits the virtual divisional area F and enters the road R2.

FIG. 16 illustrates the pass schedule in each virtual divisional area in a case where the autonomous driving vehicle 3 turns left at the intersection CR, in the traffic control device 500 according to the first embodiment. In FIG. 16, the entire pass schedule in a case where the autonomous driving vehicle 3 turns left is shown for respective virtual divisional areas.

Before time I, the virtual divisional areas P and A become to-be-passed areas. At time I, the autonomous driving vehicle 3 enters the virtual divisional area P from the road R1, so that the virtual divisional area P becomes a being-passed area and the virtual divisional area A becomes a to-be-passed area. During a period from time I to time II, the virtual divisional area A changes from a to-be-passed area to a being-passed area. In addition, during the period from time I to time II, the virtual divisional area F becomes a to-be-passed area.

At time II, the virtual divisional areas P and A are being-passed areas and the virtual divisional area F is a to-be-passed area. During a period from time II to time III, the virtual divisional area F changes from a to-be-passed area to a being-passed area. Meanwhile, during the period from the time II to the time III, the virtual divisional area P changes from a being-passed area to an area that is neither a to-be-passed area nor a being-passed area. This is because the autonomous driving vehicle 3 exits the virtual divisional area P.

At time III, the virtual divisional areas A and F are being-passed areas. At time IV, the virtual divisional area F changes from a being-passed area to an area that is neither a to-be-passed area nor a being-passed area.

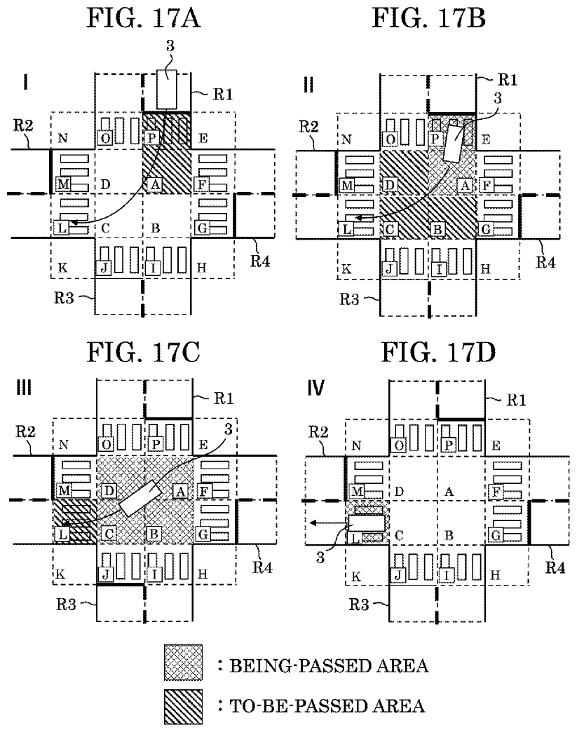

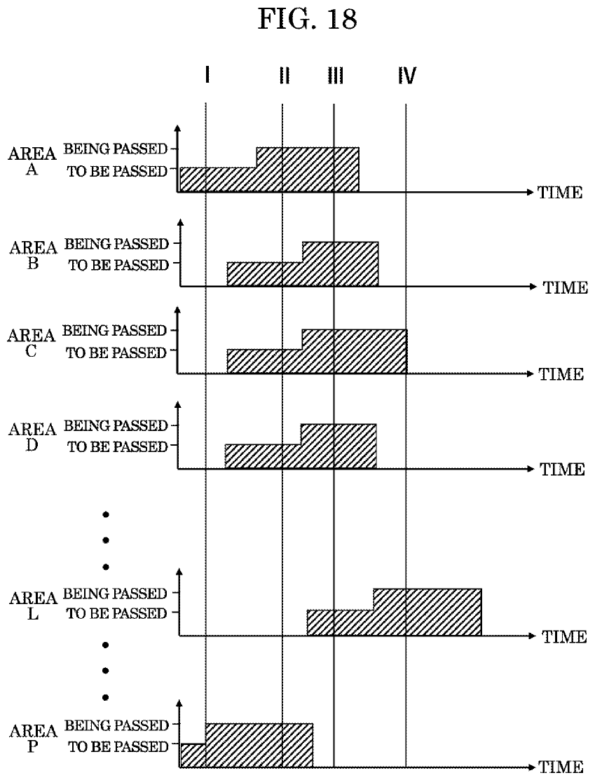

The pass schedule in a case where the autonomous driving vehicle 3 turns right will be described with reference to FIG. 17A to 17D and FIG. 18. FIG. 17A to 17D are schematic diagrams illustrating generation of the pass schedule in a case where the autonomous driving vehicle 3 turns right at the intersection CR, in the traffic control device 500 according to the first embodiment. In an example shown in FIG. 17A to 17D, the autonomous driving vehicle 3 enters the intersection CR from the road R1, turns right to pass the virtual divisional areas P, A, D, B, C, and L, and enters the road R4.

FIG. 17A shows a situation at time I just before the autonomous driving vehicle 3 enters the virtual divisional area P from the road R1, FIG. 17B shows a situation at time II when the autonomous driving vehicle 3 enters the virtual divisional area A, FIG. 17C shows a situation at time III when the autonomous driving vehicle 3 is passing the center of the intersection CR, and FIG. 17D shows a situation at time IV just before the autonomous driving vehicle 3 exits the virtual divisional area L and enters the road R4.

FIG. 18 illustrates the pass schedule in each virtual divisional area in the case where the autonomous driving vehicle 3 turns right at the intersection CR, in the traffic control device 500 according the first embodiment. In FIG. 18, the entire pass schedule in the case where the autonomous driving vehicle 3 turns right is shown for respective virtual divisional areas.

Just before time I, the virtual divisional areas P and A become to-be-passed areas. At time I, the autonomous driving vehicle 3 enters the virtual divisional area P from the road R1, so that the virtual divisional area P becomes a being-passed area and the virtual divisional area A becomes a to-be-passed area. During a period from time I to time II, the virtual divisional area A changes from a to-be-passed area to a being-passed area. In addition, during the period from time I to time II, the virtual divisional areas B, C, and D become to-be-passed areas.

At time II, the virtual divisional areas P and A are being-passed areas and the virtual divisional areas B, C, and D are to-be-passed areas. During a period from time II to time III, the virtual divisional areas B, C, and D change from to-be-passed areas to being-passed areas. Meanwhile, during the period from time II to time III, the virtual divisional area P changes from a being-passed area to an area that is neither a to-be-passed area nor a being-passed area. This is because the autonomous driving vehicle 3 exits the virtual divisional area P. In addition, during the period from time II to time III, the virtual divisional area L changes from an area that is neither a to-be-passed area nor a being-passed area, to a to-be-passed area.

At time III, the virtual divisional areas A, B, C, and D are being-passed areas. During a period from time III to time IV, the virtual divisional area L changes from a to-be-passed area to a being-passed area, and meanwhile, the virtual divisional areas A, B, and D change from being-passed areas to areas that are neither to-be-passed areas nor being-passed areas. At time IV, the virtual divisional area L is a being-passed area and the virtual divisional area C changes from a being-passed area to an area that is neither a to-be-passed area nor a being-passed area.

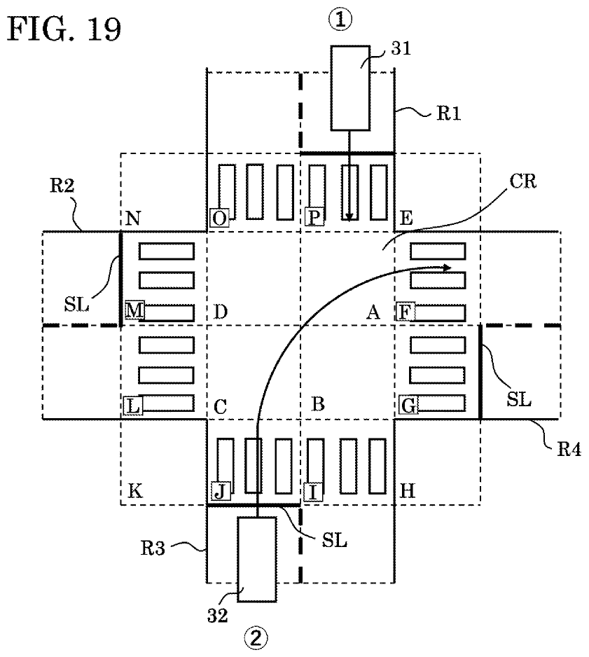

Next, a case where a plurality of autonomous driving vehicles 31 and 32 enter the intersection CR will be described. FIG. 19 is a schematic diagram illustrating a case where a plurality of autonomous driving vehicles 31 and 32 enter the intersection CR, in the traffic control device 500 according to the first embodiment. The autonomous driving vehicle to enter the intersection from the road R1 is defined as the autonomous driving vehicle 31, and the autonomous driving vehicle to enter the intersection CR from the road R3 is defined as the autonomous driving vehicle 32.

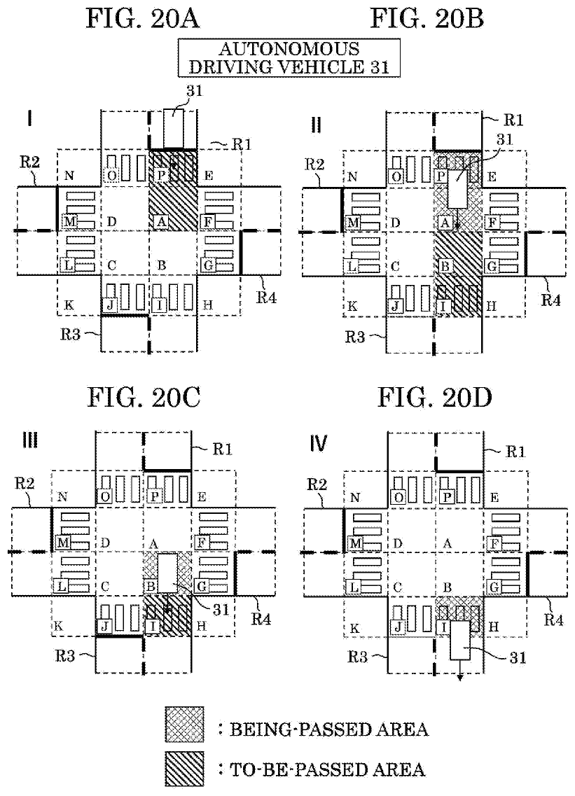

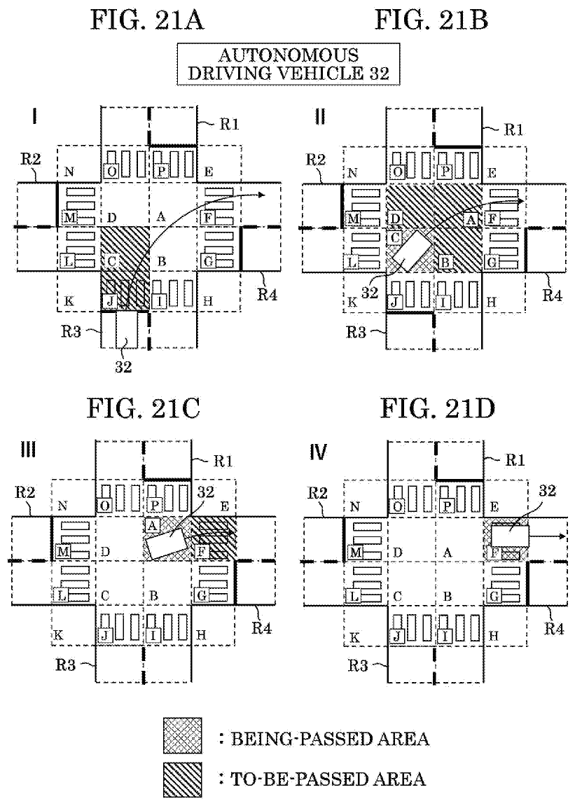

Behaviors of the autonomous driving vehicle 31 and the autonomous driving vehicle 32 in an example shown in FIG. 19 will be described with reference to schematic diagrams in FIG. 20A to 20D and FIG. 21A to 21D. FIG. 20A to 20D are schematic diagrams showing the behavior of the autonomous driving vehicle 31 at the intersection CR, and FIG. 21A to 21D are schematic diagrams showing the behavior of the autonomous driving vehicle 32 at the intersection CR.

As shown in FIG. 20A to 20D, the autonomous driving vehicle 31 enters the intersection CR from the road R1, moves straight to pass the intersection CR, and enters the road R1 again. Since the autonomous driving vehicle 31 moves straight, the autonomous driving vehicle 31 enters the intersection CR from the virtual divisional area P, and then passes the virtual divisional areas P, A, B, and I in this order, to enter the road R1 from the virtual divisional area I again.

As shown in FIG. 21A to 21D, the autonomous driving vehicle 32 enters the intersection CR from the road R3, turns right to pass the intersection CR, and enters the road R2. Since the autonomous driving vehicle 32 turns right, the autonomous driving vehicle 32 enters the intersection from the virtual divisional area J, passes the virtual divisional areas J, C, D, B, A, and F, and then enters the road R2 from the virtual divisional area F.

In FIG. 19, the autonomous driving vehicle 31 is allocated with a number “1”, and the autonomous driving vehicle 32 is allocated with a number “2”. These numbers represent passing order ranks set after collision judgment, and the details thereof will be described later. At first, it is assumed that the autonomous driving vehicle 31 and the autonomous driving vehicle 32 simultaneously enter the intersection CR. The time when each autonomous driving vehicle starts to move toward the intersection CR is defined as time tA.

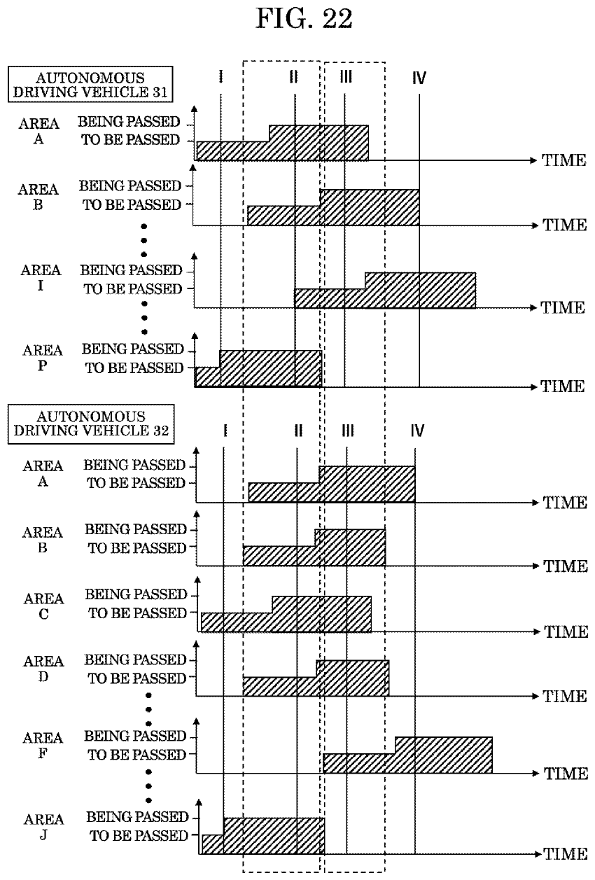

The pass schedules in the example in FIG. 20A to 20D and FIG. 21A to 21D are shown in FIG. 22. FIG. 22 illustrates the pass schedules in each virtual divisional area for the respective autonomous driving vehicles in the case where the two autonomous driving vehicles 31 and 32 enter the intersection CR, in the traffic control device 500 according to the first embodiment. Time points shown in FIG. 22 are exemplary time points for comparison.

Next, collision judgment in the traffic control device 500 according to the first embodiment will be described. In the function block diagram showing the configuration of the traffic control device 500 according to the first embodiment shown in FIG. 2, the collision judgment unit 232 judges whether or not there is a collision possibility between the vehicle 2 and the vehicle 2 or between the vehicle 2 and the pedestrian 5 by comparing the pass schedules of the respective vehicles 2 and pedestrians 5 in each virtual divisional area. The collision judgment is performed also for collision that does not involve the autonomous driving vehicle 3. For example, a collision possibility between the manual driving vehicles 4 or between the manual driving vehicle 4 and the pedestrian 5 is also judged.

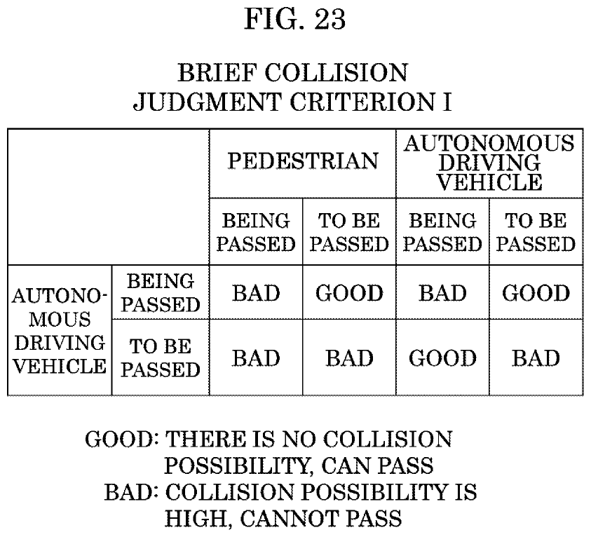

FIG. 23 shows an example of the collision judgment criterion in the traffic control device 500 according to the first embodiment. The collision judgment criterion shown in FIG. 23 is referred to as a brief collision judgment criterion I. As shown in FIG. 23, in a case where the same virtual divisional area becomes a being-passed area for a plurality of autonomous driving vehicles 3 at the same time and in a case where the same virtual divisional area becomes a to-be-passed area for a plurality of autonomous driving vehicles 3 at the same time, the collision judgment unit 232 judges that there is a collision possibility between the plurality of autonomous driving vehicles 3.

In other words, among a plurality of autonomous driving vehicles 3, in a case where a time period in which a specific virtual divisional area becomes a being-passed area for a first autonomous driving vehicle 3 and a time period in which the specific virtual divisional area becomes a being-passed area for a second autonomous driving vehicle 3 different from the first autonomous driving vehicle 3, overlap each other, or in a case where a time period in which a specific virtual divisional area becomes a to-be-passed area for the first autonomous driving vehicle 3 and a time period in which the specific virtual divisional area becomes a to-be-passed area for the second autonomous driving vehicle 3, overlap each other, it is judged that the possibility of collision between the first autonomous driving vehicle 3 and the second autonomous driving vehicle 3 is high.

In addition, between the autonomous driving vehicle 3 and the pedestrian 5, in a case where a time period in which a specific virtual divisional area becomes a being-passed area for the autonomous driving vehicle 3 and a time period in which the specific virtual divisional area becomes a being-passed area for the pedestrian 5, overlap each other, or in a case where a time period in which a specific virtual divisional area becomes a to-be-passed area for the autonomous driving vehicle 3 and a time period in which the specific virtual divisional area becomes a to-be-passed area for the pedestrian 5, overlap each other, it is judged that the collision possibility between the autonomous driving vehicle 3 and the pedestrian 5 is high. In addition, in a case where a time period in which a specific virtual divisional area becomes a to-be-passed area for the autonomous driving vehicle 3 and a time period in which the specific virtual divisional area becomes a being-passed area for the pedestrian 5, overlap each other, it is judged that the possibility of collision between the autonomous driving vehicle 3 and the pedestrian 5 is high.

On the other hand, in a case where the same virtual divisional area is a being-passed area for the first autonomous driving vehicle 3 and is also a to-be-passed area for the second autonomous driving vehicle 3 at the same time, it is judged that there is no collision possibility between the first autonomous driving vehicle 3 and the second autonomous driving vehicle 3. In addition, in a case where a time period in which a specific virtual divisional area becomes a being-passed area for the autonomous driving vehicle 3 and a time period in which the specific virtual divisional area becomes a to-be-passed area for the pedestrian 5, overlap each other, it is judged that there is no collision possibility between the autonomous driving vehicle 3 and the pedestrian 5.

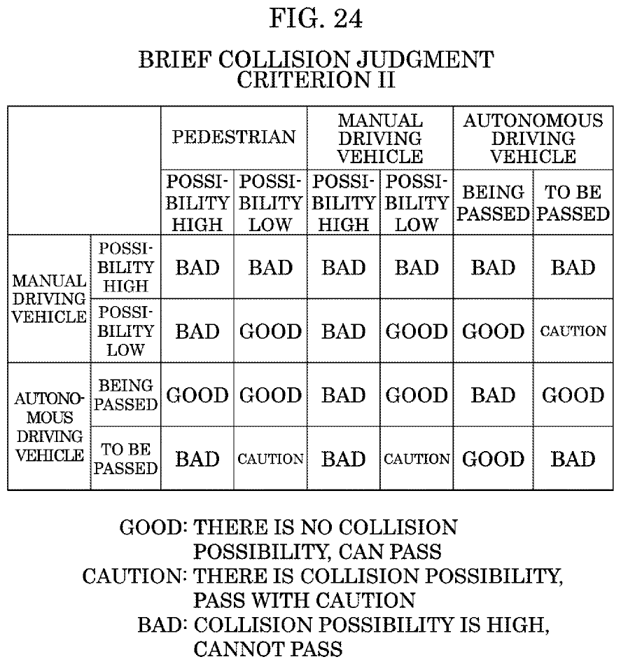

FIG. 24 shows another example of a collision judgment criterion different from FIG. 23, in the traffic control device 500 according to the first embodiment. The collision judgment criterion shown in FIG. 24 is referred to as a brief collision judgment criterion II. In FIG. 24, with respect to the manual driving vehicle 4 and the pedestrian 5, collision judgment is performed on the basis of whether the possibility of presence thereof in a virtual divisional area that is a subject (hereinafter, referred to as subject virtual divisional area) is high or low. On the other hand, with respect to the autonomous driving vehicle 3, collision judgment is performed on the basis of whether the subject virtual divisional area is a being-passed area or a to-be-passed area.

In a case where the possibility that the manual driving vehicle 4 is present in the subject virtual divisional area is high, it is judged that the collision possibilities between the manual driving vehicle 4 and another manual driving vehicle 4 and between the manual driving vehicle 4 and the pedestrian 5 are high, irrespective of whether or not the possibilities that the pedestrian 5 and another manual driving vehicle 4 are present in the subject virtual divisional area are high or low. That is, the manual driving vehicle 4 cannot pass the subject virtual divisional area.

In a case where the possibility that the manual driving vehicle 4 is present in the subject virtual divisional area is high and the subject virtual divisional area is a being-passed area or a to-be-passed area for the autonomous driving vehicle 3, it is judged that the collision possibility between the manual driving vehicle 4 and the autonomous driving vehicle 3 is high. That is, the manual driving vehicle 4 cannot pass the subject virtual divisional area.

In a case where the possibility that the manual driving vehicle 4 is present in the subject virtual divisional area is low and the possibilities that the pedestrian 5 and another manual driving vehicle 4 are present in the subject virtual divisional area are high, it is judged that the collision possibilities between the manual driving vehicle 4 and another manual driving vehicle 4 and between the manual driving vehicle 4 and the pedestrian 5 are high. That is, the manual driving vehicle 4 cannot pass the subject virtual divisional area.

In a case where the possibility that the manual driving vehicle 4 is present in the subject virtual divisional area is low and the subject virtual divisional area is a being-passed area for the autonomous driving vehicle 3, it is judged that there is no collision possibility between the manual driving vehicle 4 and the autonomous driving vehicle 3. That is, the manual driving vehicle 4 can pass the subject virtual divisional area.

On the other hand, in a case where the possibility that the manual driving vehicle 4 is present in the subject virtual divisional area is low and the subject virtual divisional area is a to-be-passed area for the autonomous driving vehicle 3, it is judged that there is a collision possibility between the manual driving vehicle 4 and the autonomous driving vehicle 3. That is, the manual driving vehicle 4 needs to travel with caution for the subject virtual divisional area.

In a case where the subject virtual divisional area is a being-passed area for the autonomous driving vehicle 3, it is judged that there is no collision possibility between the autonomous driving vehicle 3 and the pedestrian 5, irrespective of whether the possibility that the pedestrian 5 is present in the subject virtual divisional area is high or low.

In a case where the subject virtual divisional area is a being-passed area for the autonomous driving vehicle 3 and the possibility that the manual driving vehicle 4 is present in the subject virtual divisional area is high, it is judged that the collision possibility between the autonomous driving vehicle 3 and the manual driving vehicle 4 is high. On the other hand, in a case where the possibility that the manual driving vehicle 4 is present in the subject virtual divisional area is low, it is judged that there is no collision possibility between the autonomous driving vehicle 3 and the manual driving vehicle 4.

In a case where the subject virtual divisional area is a being-passed area for the autonomous driving vehicle 3 and the subject virtual divisional area is a being-passed area for another autonomous driving vehicle 3, it is judged that the collision possibility between the autonomous driving vehicle 3 and the other autonomous driving vehicle 3 is high. On the other hand, in a case where the subject virtual divisional area is a to-be-passed area for another autonomous driving vehicle 3, it is judged that there is no collision possibility between the autonomous driving vehicle 3 and the other autonomous driving vehicle 3.

In a case where the subject virtual divisional area is a to-be-passed area for the autonomous driving vehicle 3 and the possibility that the pedestrian 5 is present in the subject virtual divisional area is high, it is judged that the collision possibility between the autonomous driving vehicle 3 and the pedestrian 5 is high. On the other hand, in a case where the subject virtual divisional area is a to-be-passed area for the autonomous driving vehicle 3 and the possibility that the pedestrian 5 is present in the subject virtual divisional area is low, it is judged that there is a collision possibility between the autonomous driving vehicle 3 and the pedestrian 5.

In a case where the subject virtual divisional area is a to-be-passed area for the autonomous driving vehicle 3 and the possibility that the manual driving vehicle 4 is present in the subject virtual divisional area is high, it is judged that the collision possibility between the autonomous driving vehicle 3 and the manual driving vehicle 4 is high. On the other hand, in a case where the subject virtual divisional area is a to-be-passed area for the autonomous driving vehicle 3 and the possibility that the manual driving vehicle 4 is present in the subject virtual divisional area is low, it is judged that there is a collision possibility between the autonomous driving vehicle 3 and the manual driving vehicle 4.

In a case where the subject virtual divisional area is a to-be-passed area for the autonomous driving vehicle 3 and the subject virtual divisional area is a being-passed area for another autonomous driving vehicle 3, it is judged that there is no collision possibility between the autonomous driving vehicle 3 and the other autonomous driving vehicle 3. On the other hand, in a case where the subject virtual divisional area is a to-be-passed area for the autonomous driving vehicle 3 and the subject virtual divisional area is a to-be-passed area for another autonomous driving vehicle 3, it is judged that the collision possibility between the autonomous driving vehicle 3 and the other autonomous driving vehicle 3 is high.

Although not shown in the brief collision judgment criterions I and II in FIG. 23 and FIG. 24, in a case where the subject virtual divisional area is a being-passed area or a to-be-passed area for one of the autonomous driving vehicles 3 compared to each other and the subject virtual divisional area is neither a being-passed area nor a to-be-passed area for another autonomous driving vehicle 3, it is judged that there is no collision possibility between the one autonomous driving vehicle 3 and the other autonomous driving vehicle 3.

The reason why it is judged that there is a collision possibility for a combination of a to-be-passed area for one autonomous driving vehicle 3 and a to-be-passed area for another autonomous driving vehicle 3, is that, if the passing time of one autonomous driving vehicle 3 is shifted for some reason, the passing time of the autonomous driving vehicle 3 might overlap the passing time of the other autonomous driving vehicle 3.

The reason why it is judged that there is no collision possibility for a combination of a being-passed area for one autonomous driving vehicle 3 and a to-be-passed area for another autonomous driving vehicle 3, is that, if the subject virtual divisional area is a being-passed area for one autonomous driving vehicle 3, it is considered that the other autonomous driving vehicle 3 immediately exits the subject virtual divisional area.

The collision possibility in the example shown in FIG. 20 and FIG. 21 is judged on the basis of the brief collision judgment criterion I shown in FIG. 23 or the brief collision judgment criterion II shown in FIG. 24. According to the pass schedules for the autonomous driving vehicle 31 and the autonomous driving vehicle 32 shown in FIG. 22, in time periods respectively enclosed by two dotted lines, there is a time period in which the virtual divisional area A is a to-be-passed area for the autonomous driving vehicle 31 and the autonomous driving vehicle 32. Therefore, it is judged that the possibility that the autonomous driving vehicle 31 and the autonomous driving vehicle 32 collide with each other in the virtual divisional area A is high.

In the time periods respectively enclosed by two dotted lines, there is a time period in which the virtual divisional area B is a to-be-passed area for the autonomous driving vehicle 31 and the autonomous driving vehicle 32. Further, there is also a time period in which the virtual divisional area B is a being-passed area for the autonomous driving vehicle 31 and the autonomous driving vehicle 32.

From the above, in the example shown in FIG. 20 and FIG. 21, for the virtual divisional areas A and B, it is judged that the collision possibility between the autonomous driving vehicle 31 and the autonomous driving vehicle 32 is high. In the other virtual divisional areas, each of the autonomous driving vehicle 31 and the autonomous driving vehicle 32 passes alone or no autonomous driving vehicle is planned to pass, and therefore it is judged that there is no collision possibility between the autonomous driving vehicle 31 and the autonomous driving vehicle 32.

As described above, in the example shown in FIG. 20 and FIG. 21, there is a possibility of causing collision between the autonomous driving vehicle 31 and the autonomous driving vehicle 32, and therefore it is necessary to adjust the passing times of the autonomous driving vehicles so as not to cause collision.

In the traffic control device 500 according to the first embodiment, if the collision judgment unit 232 judges that there is a collision possibility between the vehicle 2 and the vehicle 2 or between the vehicle 2 and the pedestrian 5, passing order ranks for the vehicles 2 are set on the basis of predetermined priorities, and after the passing order ranks are set, the degrees in which the passing times of the vehicles 2 to pass the intersection CR are to be delayed are determined.

If the passing order rank setting unit 241 has received a judgment result that there is a collision possibility from the collision judgment unit 232, the passing order rank setting unit 241 reads predetermined priorities from the priority storage unit 253, and sets an order for each vehicle 2 to pass the intersection CR by referring to the traffic information X and the target passing direction information Y.

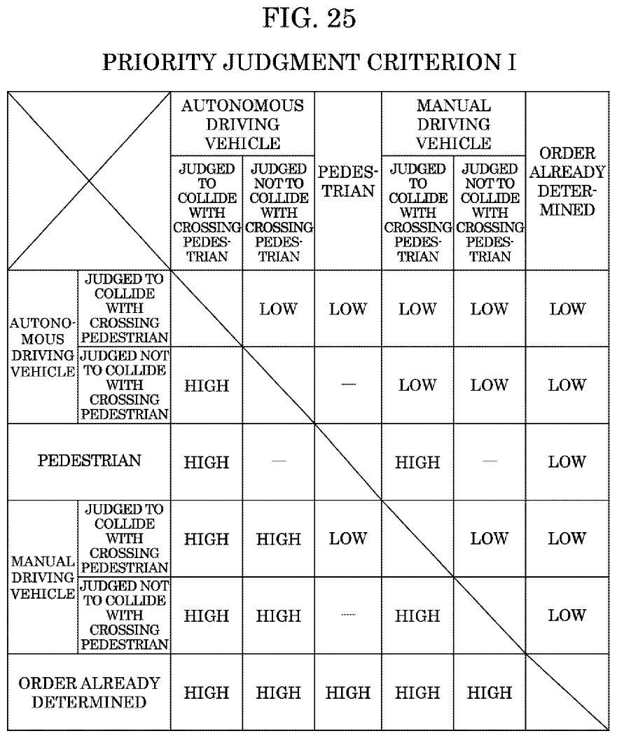

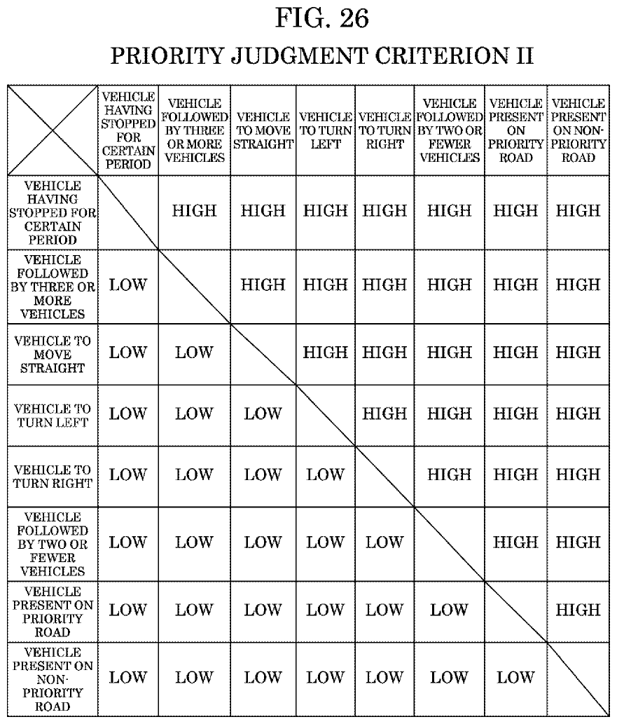

As the “predetermined priorities”, various examples are conceivable. In the traffic control device 500 according to the first embodiment, the priorities are set on the basis of a priority judgment criterion I shown in FIG. 25 or a priority judgment criterion II shown in FIG. 26.

The priority judgment criterion I shown in FIG. 25 indicates priorities for subject objects listed in the leftmost column relative to compared objects listed in the uppermost row. Here, “HIGH” is written for a case where the subject object is prioritized, “LOW” is written for a case where the subject object is not prioritized, and “-” is written for a case where the priority is not determined. For example, the autonomous driving vehicle 3 judged to have a possibility of collision with the pedestrian 5 who is crossing is set at a lower priority, i.e., “LOW”, relative to the autonomous driving vehicle 3 judged to have no possibility of collision with the pedestrian 5 who is crossing.

The priority judgment criterion II shown in FIG. 26 indicates priorities of subject objects listed in the leftmost column relative to compared objects listed in the uppermost row. Here, “HIGH” is written for a case where the subject object is prioritized, and “LOW” is written for a case where the subject object is not prioritized. For example, the vehicle 2 to move straight is set at a higher priority, i.e., “HIGH”, relative to the vehicle 2 to turn left or right.

In a case of using the priority judgment criterion I shown in FIG. 25, it is possible to easily judge which of subject moving objects has a higher priority through comparison between the subject moving objects. In a case of using the priority judgment criterion II shown in FIG. 26, it is possible to easily judge which has a higher priority between moving objects that cannot be judged using the priority judgment criterion I.

On the basis of the priority judgment criterions I and II, two moving objects are compared with each other to determine priorities. That is, while two moving objects are sequentially compared to each other, the priority for each moving object is sequentially determined. The priorities are set for not only the autonomous driving vehicles 3 but all the vehicles 2 and the pedestrians 5 that are present in the intersection area, i.e., all the moving objects.

The priorities shown in FIG. 25 and FIG. 26 are priorities for setting the passing order ranks of the vehicles 2 to enter the intersection CR from different roads. For a plurality of vehicles 2 traveling on the same road, priorities are set so that the top vehicle 2 passes the intersection CR first, i.e., the closer to the intersection CR the vehicle 2 is, the higher the priority therefor is.

As a result of the above, whether or not there is a possibility of causing collision between the moving objects is judged and the passing order ranks of the moving objects are set, and therefore it becomes necessary to adjust the pass schedules for the moving objects on the basis of the passing order ranks. The pass schedules after the adjustment are referred to as adjusted pass schedules.

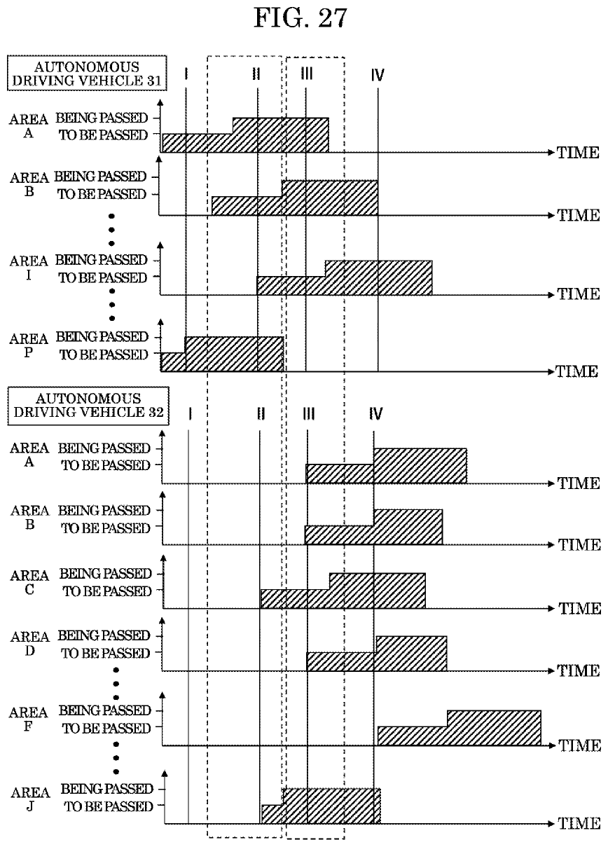

FIG. 27 shows adjusted pass schedules obtained by calculating an adjustment period on the basis of the pass schedules in FIG. 22 and then performing adjustment in consideration of the adjustment period. In the pass schedules shown in FIG. 22, a state in which the same virtual divisional area is a to-be-passed area for the autonomous driving vehicle 31 and a to-be-passed area for the autonomous driving vehicle 32 arises in the time periods respectively enclosed by two dotted lines, whereas this state is eliminated in the adjusted pass schedules shown in FIG. 27. In the adjusted pass schedules, it is found that, even when the autonomous driving vehicle 31 is in a being-passed area, the same area is not a being-passed area for the autonomous driving vehicle 32, and therefore a collision possibility is no longer present between the autonomous driving vehicle 31 and the autonomous driving vehicle 32.

Although a scene for only the autonomous driving vehicles 3 is described in the adjusted pass schedules shown in FIG. 27, adjustment of the pass schedules is performed for all the vehicles 2 and the pedestrians 5 in the intersection area on the basis of the above passing order ranks.

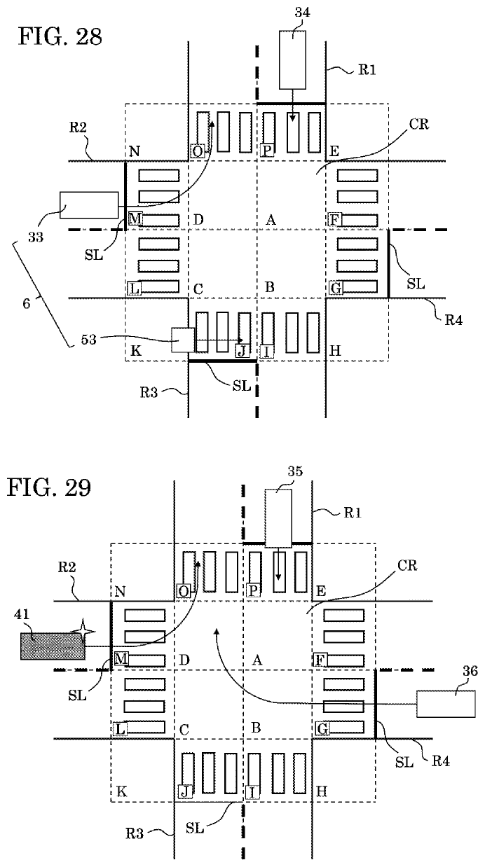

In a case where two autonomous driving vehicles 3 and one pedestrian 5 move on the intersection CR in an example shown in FIG. 28, setting of the passing order ranks of the moving objects on the basis of the above priorities will be described. In the example shown in FIG. 28, an autonomous driving vehicle 34 enters the intersection CR from the road R1 and moves straight through the intersection CR, and therefore there is a possibility that the autonomous driving vehicle 34 collides with a pedestrian 53 crossing a crosswalk across the road R3 and the road R1. Thus, the priority for the autonomous driving vehicle 34 is set to be lowest.

An autonomous driving vehicle 33 enters the intersection CR from the road R2 and turns left at the intersection CR toward the road R3, and therefore there is no pedestrian 53 crossing a crosswalk present on the traveling route of the autonomous driving vehicle 33. Thus, the priorities for the autonomous driving vehicle 33 and the pedestrian 53 are set to be highest. Accordingly, the passing order ranks of the autonomous driving vehicle 33 and the pedestrian 53 are the first rank, and the passing order rank of the autonomous driving vehicle 34 is the second rank. Here, since there is no possibility of collision between the autonomous driving vehicle 33 and the pedestrian 53, both advance simultaneously.

A case of setting the passing order ranks of the vehicles 2 in an example shown in FIG. 29 on the basis of the above priorities will be described. In the example shown in FIG. 29, a manual driving vehicle 41 enters the intersection CR from the road R2 and turns left at the intersection CR toward the road R3. An autonomous driving vehicle 35 enters the intersection CR from the road R1 and moves straight through the intersection CR. An autonomous driving vehicle 36 enters the intersection CR from the road R4 and turns right at the intersection CR toward the road R3.

Between the manual driving vehicle 41 and the autonomous driving vehicle 36, the priority for the manual driving vehicle 41 is set to be higher. This is because, according to the priority judgment criterion II in FIG. 26, a vehicle to turn left has a higher priority than a vehicle to turn right. Meanwhile, between the autonomous driving vehicle 35 and the autonomous driving vehicle 36, the priority for the autonomous driving vehicle 35 is set to be higher. This is because, according to the priority judgment criterion II in FIG. 26, a vehicle to move straight has a higher priority than a vehicle to turn right.

Between the manual driving vehicle 41 and the autonomous driving vehicle 35, the priority for the manual driving vehicle 41 is higher, but there is no possibility of collision therebetween and therefore they are set at the same passing order rank. Accordingly, the passing order ranks of the manual driving vehicle 41 and the autonomous driving vehicle 35 are set to be the first rank, and the passing order rank of the autonomous driving vehicle 36 is set to be the second rank. Here, since there is no possibility of collision between the manual driving vehicle 41 and the autonomous driving vehicle 35, both advance simultaneously.

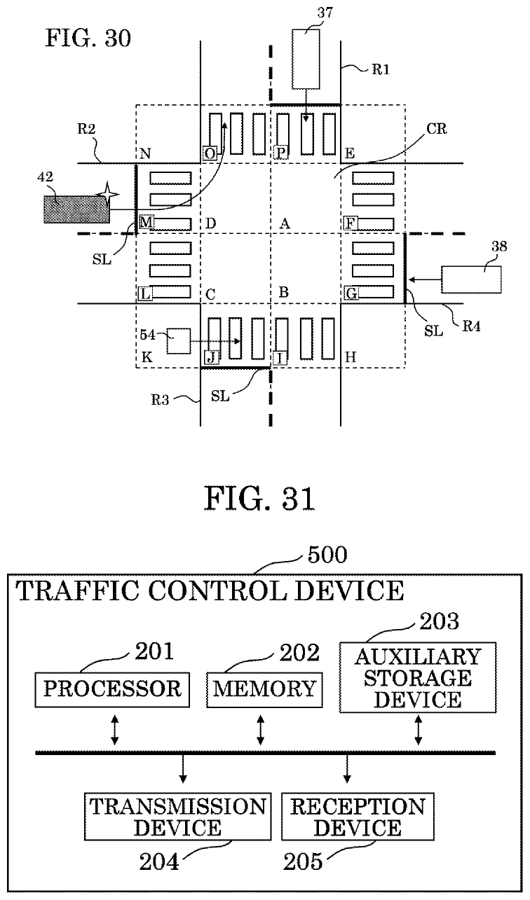

A case of setting the passing order ranks of the vehicles and the pedestrian in an example shown in FIG. 30 on the basis of the above priorities will be described. In the example shown in FIG. 30, a manual driving vehicle 42 enters the intersection CR from the road R2 and turns left at the intersection CR toward the road R3. An autonomous driving vehicle 37 enters the intersection CR from the road R1 and moves straight through the intersection CR. An autonomous driving vehicle 38 enters the intersection CR from the road R4 and moves straight through the intersection CR. A pedestrian 54 crosses a crosswalk across the road R3 and the road R1.

Between the manual driving vehicle 42 and the autonomous driving vehicle 38, the priority for the manual driving vehicle 42 is set to be higher. Between the autonomous driving vehicle 38 and the autonomous driving vehicle 37, the priority for the autonomous driving vehicle 37 is set to be higher. Between the manual driving vehicle 42 and the autonomous driving vehicle 37, the priority for the manual driving vehicle 42 is set to be higher. Between the autonomous driving vehicle 37 and the pedestrian 54, there is a possibility of collision and therefore the priority for the pedestrian 54 is set to be higher. Accordingly, the passing order ranks of the pedestrian 54 and the manual driving vehicle 42 are the first rank, the passing order rank of the autonomous driving vehicle 37 is the second rank, and the passing order rank of the autonomous driving vehicle 38 is the third rank. Here, since there is no possibility of collision between the pedestrian 54 and the manual driving vehicle 42, both advance simultaneously.

Next, a hardware configuration for implementing the traffic control device 500 according to the first embodiment will be described. FIG. 31 shows an example of the hardware configuration for implementing the traffic control device 500 according to the first embodiment. The traffic control device 500 is mainly composed of a processor 201, a memory 202 as a main storage device, and an auxiliary storage device 203. The processor 201 is composed of, for example, a central processing unit (CPU), an application specific integrated circuit (ASIC), a digital signal processor (DSP), a field programmable gate array (FPGA), or the like.

The memory 202 is composed of a volatile storage device such as a random access memory, and the auxiliary storage device 203 is composed of a nonvolatile storage device such as a flash memory, a hard disk, or the like. A predetermined program to be executed by the processor 201 is stored in the auxiliary storage device 203, and the processor 201 reads and executes the program as appropriate, to perform various calculation processes. In this case, the predetermined program is temporarily stored into the memory 202 from the auxiliary storage device 203, and the processor 201 reads the program from the memory 202. Various calculation processes in a control system according to the first embodiment are implemented by the processor 201 executing the predetermined program as described above. A result of the calculation process by the processor 201 is stored into the memory 202 once and is stored into the auxiliary storage device 203 in accordance with the purpose of the executed calculation process.

In addition, the traffic control device 500 includes a transmission device 204 for transmitting data to the autonomous driving vehicle 3 and an external device such as the traffic environment recognition device 1, and a reception device 205 for receiving data from the autonomous driving vehicle 3 and the external device such as the traffic environment recognition device 1.

The communication unit 21 which performs transmission and reception of various data is implemented by the transmission device 204 and the reception device 205 shown in FIG. 31. The recognition unit 22, the determination unit 23, and the adjustment unit 24 which perform various calculation processes are implemented by the processor 201, the memory 202, and the auxiliary storage device 203. In addition, the storage unit 25 is implemented by the memory 202 or the auxiliary storage device 203.

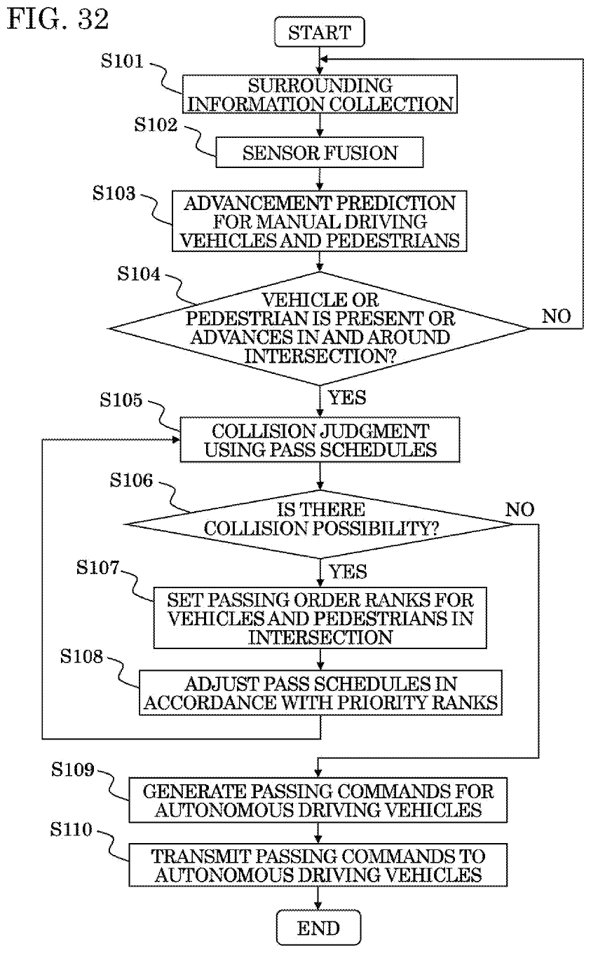

Next, operation of the traffic control device 500 according to the first embodiment will be described. FIG. 32 is a flowchart showing operation of the traffic control device 500 according to the first embodiment. The traffic control device 500 repeatedly executes the flowchart shown in FIG. 32 at a predetermined cycle (e.g., one second). Through repetitive execution of the flowchart shown in FIG. 32 at the predetermined cycle as described above, the pass schedules are periodically updated. Therefore, even if there is a difference between the actual behavior of each moving object 6 and the pass schedule generated at first or the adjusted pass schedule after adjustment, it is possible to immediately cope therewith. As a result, in the intersection area, even in a case where the autonomous driving vehicles 3, the manual driving vehicles 4, and the pedestrians 5 are present together, smooth traffic is achieved while collision between the moving objects 6 is avoided.

First, in step S101 (surrounding information collection step), the traffic control device 500 collects information about the vehicles 2 and pedestrians (moving objects 6) in the intersection area, i.e., the traffic information X and the target passing direction information Y, by the traffic environment recognition device 1. Then, the process proceeds to step S102.

In step S102 (sensor fusion step), pieces of surrounding information of the intersection CR are integrated using known sensor fusion technology. By using the sensor fusion technology, pieces of the above information about the moving objects 6 transmitted from a plurality of traffic environment recognition devices 1 can be integrated into information having higher accuracy. After step S102, the process proceeds to step S103.

In step S103 (advancement prediction step for the manual driving vehicles 4 and the pedestrians 5), behavior prediction for the manual driving vehicles 4 and the pedestrians 5 is performed using known technology, and entry possibility maps in which the intersection area is virtually divided into virtual divisional areas are generated on the basis of the future positions of the manual driving vehicles 4 and the pedestrians 5 obtained as a result of the behavior prediction.

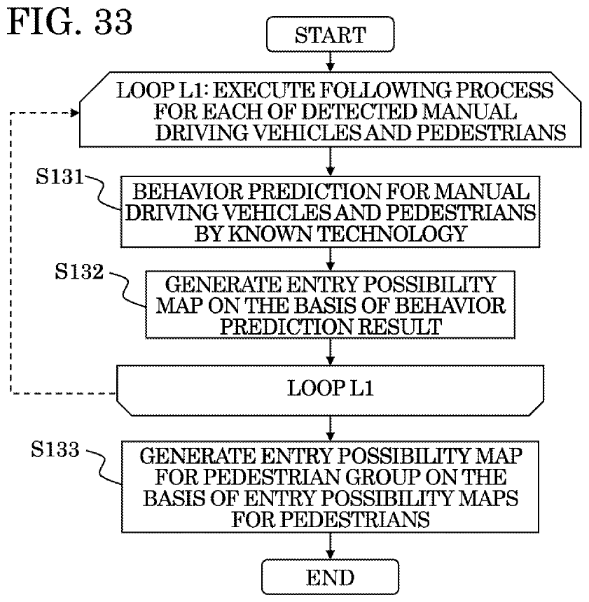

FIG. 33 is a flowchart showing the advancement prediction step for the manual driving vehicles 4 and the pedestrians 5 by the traffic control device 500 according to the first embodiment. Advancement prediction by the traffic control device 500 according to the first embodiment is performed for each of the manual driving vehicles 4 and the pedestrians 5 detected by the traffic environment recognition device 1 (loop L1).

In step S131, future position information about each of the manual driving vehicles 4 and the pedestrians 5 is acquired using known behavior prediction technology, and in step S132, an entry possibility map is generated as described above. Thereafter, in step S133, the entry possibility maps for the pedestrians 5 are integrated to generate an entry possibility map for a pedestrian group. After step S133, the process proceeds to step S104 in the flowchart shown in FIG. 32.

In step S104, whether or not the vehicle 2 or the pedestrian 5 is present in the intersection area and further whether or not the vehicle 2 or the pedestrian 5 advances, are determined, and depending on the determination result, the process changes as follows.

In step S104, if it is determined that the vehicle 2 or the pedestrian 5 is not present and does not advance (case of NO), the process returns to the surrounding information collection step in step S101.

In step S104, if it is determined that the vehicle 2 or the pedestrian 5 is present or advances (case of YES), pass schedules for the pedestrians 5 and the vehicles 2 about which vehicle information has been acquired are generated. Further, whether or not there is a possibility of causing collision between the vehicle 2 and the vehicle 2 and between the vehicle 2 and the pedestrian 5 is judged on the basis of the generated pass schedules. That is, through the processing in step S104, the pass schedules in the present state, i.e., the pass schedules for the vehicles 2 and the pedestrians 5 before adjustment are acquired, and collision judgment is performed.

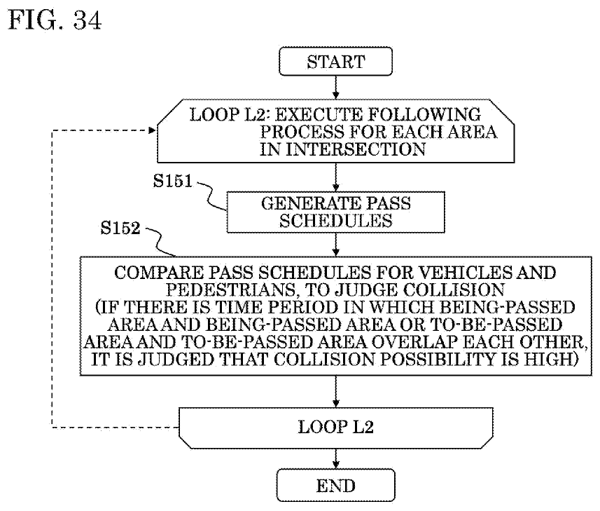

FIG. 34 is a flowchart showing a collision judgment step using the pass schedules in the traffic control device 500 according to the first embodiment. Judgment for whether or not there is a possibility of collision is as described above. In step S151, a pass schedule for each moving object is generated. Subsequently, in step S152, collision judgment between the moving objects is performed for each virtual divisional area of the intersection area (loop L2). That is, collision judgment between the moving objects is performed by comparing the pass schedules for the vehicles 2 and the pedestrians 5. In the collision judgment, for example, regarding collision between the autonomous driving vehicles 3, if there is a time period in which a being-passed area and a being-passed area or a to-be-passed area and a to-be-passed area overlap each other in the same virtual divisional area, it is judged that the possibility of collision is high.

In the above collision judgment, in step S105 (collision judgment step using pass schedules) in the flowchart shown in FIG. 32, the possibility of collision between the moving objects is judged for each virtual divisional area on the basis of the collision judgment criterion shown in FIG. 23 or FIG. 24. Depending on whether or not there is a collision possibility between the moving objects, the process changes as follows.

In step S106 (collision judgment step), if it is judged that there is a collision possibility between the moving objects (case of YES), in step S107 (passing order rank setting step for the vehicles 2 and the pedestrians 5 in the intersection CR), the passing order ranks of the moving objects are set so as to avoid collision between the moving objects. Then, the process proceeds to step S108.

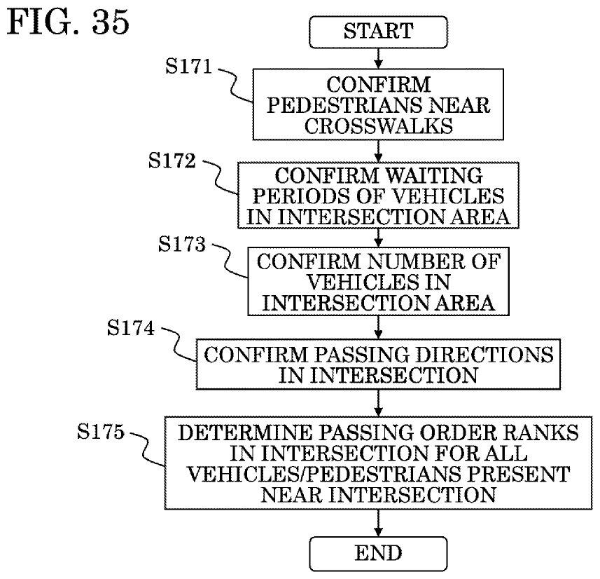

FIG. 35 is a flowchart showing step S107, i.e., the passing order rank setting step, in the traffic control device 500 according to the first embodiment. As described above, in step S107, the passing order ranks of the vehicles 2 and the pedestrians 5 to pass the intersection CR are set on the basis of the priorities shown in FIG. 25.

First, in step S171, the pedestrians 5 near the crosswalks are confirmed on the basis of the traffic information X including information about the pedestrians 5 near the crosswalks, which is acquired by the traffic environment recognition device 1 and transmitted to the traffic control device 500 according to the first embodiment. Then, the process proceeds to step S172.

In step S172, the waiting period of each vehicle 2 in the intersection area is confirmed on the basis of the traffic information X including information about each vehicle 2 in the intersection area, which is acquired by the traffic environment recognition device 1 and transmitted to the traffic control device 500 according to the first embodiment. Then, the process proceeds to step S173.

In step S173, the traffic control device 500 according to the first embodiment confirms the number of the vehicles 2 in the intersection area. Then, the process proceeds to step S174.

In step S174, the traffic control device 500 according to the first embodiment confirms the passing direction of each of the vehicles 2 and the pedestrians 5. Then, the process proceeds to step S175.

In step S175, the traffic control device 500 according to the first embodiment determines the passing order ranks at the intersection CR for all the vehicles 2 and all the pedestrians 5 present in the intersection area. After the passing order ranks are set, the process proceeds to step S108 in the flowchart shown in FIG. 32.

In step S108 (pass schedule adjustment step), the pass schedule for each of the vehicles 2 and the pedestrians 5 is adjusted as necessary.

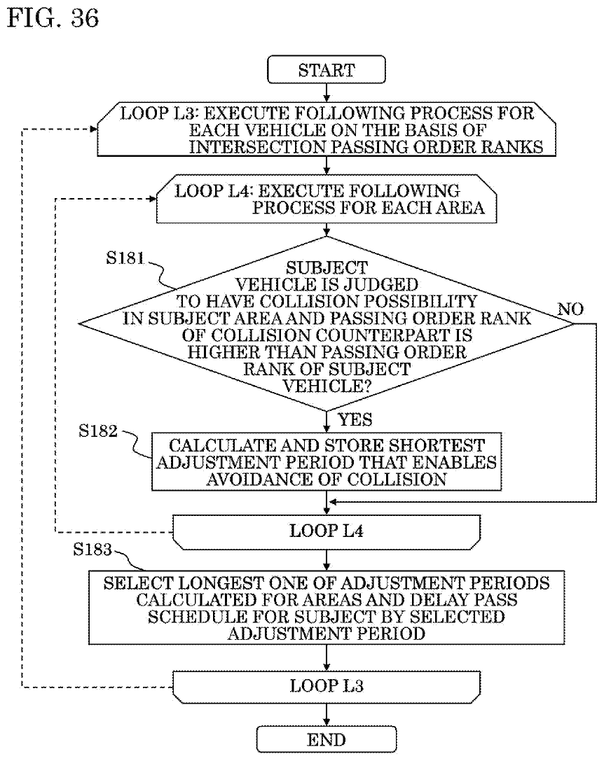

FIG. 36 is a flowchart showing a specific process in step S108 (pass schedule adjustment step). The adjustment for the pass schedules in the traffic control device 500 according to the first embodiment is performed for each of the vehicles 2 and the pedestrians 5 in the order of the passing order ranks (loop L3). The pass schedule adjustment for each of the vehicles 2 and the pedestrians 5 is performed for each virtual divisional area (loop L4). Then, the entire pass schedule is adjusted.

In the loop L3 and the loop L4, the vehicle 2 and the pedestrian 5 that are subjects for which pass schedule adjustment is performed are referred to as a “subject vehicle” and a “subject pedestrian”, respectively. Whether or not to adjust the pass schedules for the “subject vehicle” and the “subject pedestrian” is judged. Here, the virtual divisional area that is a subject for which the adjustment period is calculated is referred to as a “subject virtual divisional area”. The vehicle judged to have a possibility of causing collision with the “subject vehicle” is referred to as a “collision-counterpart vehicle”, and the pedestrian judged to have a possibility of causing collision with the “subject vehicle” is referred to as a “collision-counterpart pedestrian”.

First, in step S181, from a result of the collision judgment, if the subject vehicle or the subject pedestrian has a possibility of causing collision in the subject virtual divisional area and the passing order rank of the collision-counterpart vehicle or the collision-counterpart pedestrian is higher than the passing order rank of the subject vehicle or the subject pedestrian (case of YES), for the subject virtual divisional area, it is judged that pass schedule adjustment for the subject vehicle or the subject pedestrian needs to be performed. Then, the process proceeds to step S182.

On the other hand, in step S181, if the subject vehicle or the subject pedestrian has no possibility of causing collision in the subject virtual divisional area or if the subject vehicle or the subject pedestrian has a possibility of causing collision but the passing order rank of the collision-counterpart vehicle or pedestrian is lower than the passing order rank of the subject vehicle or the subject pedestrian (case of NO), no processing is performed. That is, for the subject virtual divisional area, pass schedule adjustment is not performed.

In a case of adjusting the pass schedule for the subject vehicle or pedestrian in the subject virtual divisional area, the pass schedule for the subject vehicle or pedestrian is adjusted so as to avoid collision. That is, the pass schedule for the subject vehicle or pedestrian is delayed.

As described above, for smooth movements in the intersection CR, it is preferable that the adjustment period is short. Therefore, the shortest period that enables avoidance of collision is stored as the adjustment period for the subject virtual divisional area. After the adjustment period for the subject virtual divisional area is stored, pass schedule adjustment for the next virtual divisional area is performed.

Through the above procedure, the process in the loop L4, i.e., the process of step S181 and step S182 is performed for all the virtual divisional areas. For the virtual divisional area for which it is judged that pass schedule adjustment is not needed, the adjustment period is set to zero.

In step S183, after the adjustment periods for the subject vehicle or the subject pedestrian are calculated as necessary for all the virtual divisional areas, the longest one of the adjustment periods for the virtual divisional areas is selected as the adjustment period for the entire pass schedule of the subject vehicle or the subject pedestrian. Then, the entire pass schedule for the subject vehicle or the subject pedestrian, i.e., the pass schedules for all the virtual divisional areas are delayed by the adjustment period.

Hereafter, pass schedule adjustment is sequentially performed for the vehicles and the pedestrians whose passing order ranks are lower than the subject vehicle or the subject pedestrian, so that the process in the loop L3, i.e., the process of the loop L4 and step S183 is eventually performed for all the vehicles and all the pedestrians.

In the above method, the pass schedule for each of the vehicles and the pedestrians is sequentially adjusted in accordance with the order of the passing order ranks. Therefore, while pass schedule adjustment for the vehicle having a higher passing order rank is sequentially reflected, pass schedule adjustment for the vehicle or the pedestrian having a lower passing order rank is adjusted.

After the pass schedule adjustment step, the collision judgment step is performed again to confirm whether or not collision possibilities are eliminated in the adjusted pass schedules after the adjustment. If it is judged that there is a collision possibility even in the adjusted pass schedules, the passing order rank setting step and the pass schedule adjustment step are repeated. The passing order rank setting step for the second time or later may be omitted. If it is expected that collision possibilities are eliminated by one time of pass schedule adjustment, the process may proceed to step S109 (command generation step) described below without performing collision judgment again.

In the step S106 (collision judgment step), if it is judged that there is no collision possibility (case of NO), in step S109 (command generation step), the command Z for each autonomous driving vehicle 3 is generated.

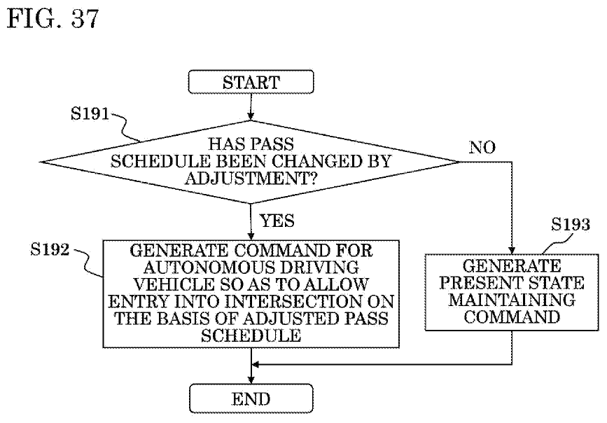

FIG. 37 is a flowchart showing operation in step S109 (command generation step) in the operation of the traffic control device 500 according to the first embodiment. In FIG. 37, generation of a command for one autonomous driving vehicle 3 among the autonomous driving vehicles 3 to which the commands Z are to be transmitted, is shown. In actuality, for all the autonomous driving vehicles 3 that are subjects to which the commands Z are to be transmitted, a process of steps S191 to S193 described below is performed to generate the command Z for each autonomous driving vehicle 3.

First, in step S191, whether or not the pass schedule has been changed by the adjustment is judged. If the pass schedule has been changed by the adjustment (case of YES), in step S192, an adjustment command is generated so that the subject autonomous driving vehicle 3 will enter the intersection CR in accordance with the adjusted pass schedule. On the other hand, if the pass schedule has not been changed (case of NO), in step S193, a present state maintaining command is generated so as not to adjust passing of the autonomous driving vehicle 3 in the intersection CR.

The adjustment command is a command for causing the autonomous driving vehicle 3 to pass the intersection CR in accordance with the adjusted pass schedule. The adjustment command includes a speed reduction command, a waiting command, and the like. The speed reduction command is for designating the degree of speed reduction and a period for performing speed reduction. The waiting command is for designating a waiting period so as to cause the autonomous driving vehicle 3 to start after the waiting period ends. That is, the waiting command serves as a passing command after elapse of the waiting period. A specific waiting period is determined on the basis of the traffic information X acquired by the traffic environment recognition device 1.

After the process of step S192 or step S193, in step S110 in the flowchart in FIG. 32, the command Z generated in the above step S109 (command generation step) is transmitted to each autonomous driving vehicle 3.

In the above description, the intersection CR is a crossroad where two-lane roads cross each other, and setting of virtual divisional areas in the intersection CR is performed accordingly. However, the traffic control device 500 according to the first embodiment is applicable to various types of intersections CR.

In the above description, the entry possibility map is converted into being-passed areas and to-be-passed areas. However, in the first embodiment, it is also possible to perform collision judgment on the basis of the priority judgment criterion II shown in FIG. 26, using the entry possibility map as it is.

In the above description, the autonomous driving vehicle 3 receives the passing order rank and the traffic information X from the traffic environment recognition device 1. However, the manual driving vehicle 4 may receive the passing order rank and the traffic information X by a communication device provided thereto, or the pedestrian 5 may receive the passing order rank and the traffic information X by a carried mobile terminal or the like. In this case, the manual driving vehicle 4 and the pedestrian 5 are to act in accordance with the determined passing order ranks.

As described above, in the traffic control device, the traffic control system, and the traffic control method according to the first embodiment, information about vehicles and pedestrians transmitted from a traffic environment recognition device installed at an intersection is received to generate pass schedules for the vehicles and the pedestrians in the intersection, a possibility of collision in the intersection is judged on the basis of the pass schedules, and if it is judged that there is a possibility of causing collision, passing order ranks are set to adjust the pass schedules, thus providing an effect of easily achieving smooth movements while avoiding occurrence of collision at the intersection where vehicles and pedestrians are present together.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 traffic environment recognition device
2 vehicle
3, 31, 32, 33, 34, 35, 36, 37, 38 autonomous driving vehicle
4, 41, 42 manual driving vehicle
5, 51, 52, 53, 54 pedestrian
6 moving object
21 communication unit
22 recognition unit
23 determination unit
24 adjustment unit
25 storage unit
221 sensor fusion unit
222 area setting unit
223 advancement prediction unit
231 pass schedule generation unit
232 collision judgment unit
241 passing order rank setting unit
242 adjusted pass schedule generation unit
243 command generation unit
251 intersection information storage unit
252 collision judgment criterion storage unit
253 priority storage unit
500 traffic control device
1000 traffic control system

What is claimed is:

1. A traffic control device comprising:
a communicator which receives
traffic information about a plurality of moving objects present in an intersection area including an intersection and an area around the intersection, the traffic information being transmitted from a traffic environment recognition device for acquiring the traffic information, and
target passing direction information transmitted from, among the plurality of moving objects, a moving object capable of communication;
a pass schedule generator which predicts a behavior in the intersection area for each of the plurality of moving objects to pass the intersection, on the basis of the traffic information and the target passing direction information, and generates a pass schedule in the intersection for each of the plurality of moving objects;
a collision judgment circuitry which judges a possibility of collision between the plurality of moving objects in the intersection on the basis of the pass schedules;
a passing order rank setter which sets passing order ranks for the plurality of moving objects to pass the intersection, if the collision judgment unit judges that there is a possibility of causing collision between the plurality of moving objects; and
an adjusted pass schedule generator which generates adjusted pass schedules by adjusting the pass schedules using the passing order ranks.

2. The traffic control device according to claim 1, wherein
the collision judgment circuitry judges again a possibility of collision when the plurality of moving objects pass the intersection on the basis of the adjusted pass schedules.

3. The traffic control device according to claim 1, further comprising an area setter which sets a plurality of virtual divisional areas by dividing the intersection area, wherein
in generation of the pass schedules and the adjusted pass schedules, movement positions of the plurality of moving objects are set for each of the virtual divisional areas.

4. The traffic control device according to claim 3, wherein
the pass schedule generator and the adjusted pass schedule generator calculate, for each of the virtual divisional areas, specifications and passing time periods of the plurality of moving objects to pass the intersection, on the basis of the traffic information and the target passing direction information.

5. The traffic control device according to claim 4, further comprising a sensor fusion circuitry which integrates at least pieces of information from a plurality of sensors provided to the traffic environment recognition device, wherein
on the basis of position information and movement information about the plurality of moving objects obtained from the sensor fusion unit, individual positions and movement directions of the plurality of moving objects in the intersection area are predicted for each of the virtual divisional areas.

6. The traffic control device according to claim 1, wherein
the communicator transmits either the pass schedule or the adjusted pass schedule to the moving object capable of communication.

7. The traffic control device according to claim 1, wherein
the plurality of moving objects include at least an autonomous driving vehicle and further include either or both of a manual driving vehicle and a pedestrian, and
the moving object capable of communication is the autonomous driving vehicle.

8. The traffic control device according to claim 7, wherein
the moving object capable of communication is the autonomous driving vehicle.

9. The traffic control device according to claim 7, wherein
regarding the manual driving vehicle and the pedestrian included in the plurality of moving objects, an entry possibility map is generated for each of the virtual divisional areas, on the basis of the specifications and the passing time periods of the manual driving vehicle and the pedestrian to pass the intersection, which are calculated for each of the virtual divisional areas.

10. The traffic control device according to claim 1, wherein
the collision judgment circuitry judges a possibility of collision on the basis of a collision judgment criterion prepared in advance.

11. The traffic control device according to claim 1, wherein
the passing order rank setter determines the passing order ranks on the basis of a priority judgment criterion prepared in advance.

12. A traffic control system comprising:
the traffic environment recognition device; and
the traffic control device according to claim 1.

13. A traffic control method comprising:
receiving
traffic information about a plurality of moving objects present in an intersection area including an intersection and an area around the intersection, the traffic information being transmitted from a traffic environment recognition device for acquiring the traffic information, and
target passing direction information transmitted from, among the plurality of moving objects, a moving object capable of communication;
predicting a behavior in the intersection area for each of the plurality of moving objects to pass the intersection, on the basis of the traffic information and the target passing direction information, and generating a pass schedule in the intersection for each of the plurality of moving objects;
judging a possibility of collision between the plurality of moving objects in the intersection on the basis of the pass schedules;
setting passing order ranks for the plurality of moving objects to pass the intersection, if it is judged in the collision judging that there is a possibility of causing collision between the plurality of moving objects; and
generating adjusted pass schedules by adjusting the pass schedules using the passing order ranks.

14. The traffic control method according to claim 13, wherein
in judging the collision, a possibility of collision when the plurality of moving objects pass the intersection is judged again on the basis of the adjusted pass schedules.

15. The traffic control method according to claim 13, further comprising setting a plurality of virtual divisional areas by dividing the intersection area, wherein
in generating pass schedules and the adjusted pass schedules, movement positions of the plurality of moving objects are set for each of the virtual divisional areas.

16. The traffic control method according to claim 15, wherein
in generating the pass schedule and the adjusted pass schedule, specifications and passing time periods of the plurality of moving objects to pass the intersection are calculated for each of the virtual divisional areas on the basis of the traffic information and the target passing direction information.

17. The traffic control method according to claim 15, wherein
the plurality of moving objects include at least an autonomous driving vehicle and further include either or both of a manual driving vehicle and a pedestrian.

18. The traffic control method according to claim 17, wherein
the moving object capable of communication is the autonomous driving vehicle.

19. The traffic control method according to claim 17, wherein
regarding the manual driving vehicle and the pedestrian included in the plurality of moving objects, an entry possibility map is generated for each of the virtual divisional areas, on the basis of the specifications and the passing time periods of the manual driving vehicle and the pedestrian to pass the intersection, which are calculated for each of the virtual divisional areas.

20. The traffic control method according to claim 13, wherein
in judging the collision, a possibility of collision is judged on the basis of a collision judgment criterion prepared in advance.
